(19) United States
(12) Patent Application Publication
(10) Pub. No.: US 2024/0012805 A1
(43) Pub. Date: Jan. 11, 2024

(54) SYSTEM AND METHOD FOR DATA RECONCILIATION AND ELECTRONIC COMMUNICATION

(71) Applicant: Veeva Systems Inc., Pleasanton, CA (US)

(72) Inventors: Mark Johnson, Livermore, CA (US); Drew Garty, Oregon, WI (US); Cheryl Bellavia Lund, Pleasanton, CA (US); Anthony Tsai, Los Angeles, CA (US)

(21) Appl. No.: 18/220,619

(22) Filed: Jul. 11, 2023

Related U.S. Application Data
(60) Provisional application No. 63/388,233, filed on Jul. 11, 2022.

(51) Int. Cl. G06F 16/23; G06F 16/242

(52) U.S. Cl. CPC G06F 16/2365; G06F 16/2433

(57) ABSTRACT

Data is received from a plurality of sources and in a plurality of formats. The data is transformed to be stored in a specialized database in a standardized format. Access to the specialized database is enabled over a network such that a stake-holder can view and update the data in real time through a graphical user interface. Changes in the data are detected and data outside of an expected range or criteria is flagged such that a message containing the detected changes or data outside of an expected range may be sent in real-time or near real-time to one or more stake-holders.

### CROSS-REFERENCE TO RELATED APPLICATIONS

This application claims priority to U.S. Provisional Application No. 63/388,233, filed on Jul. 11, 2022, titled “System And Method For Data Reconciliation And Electronic Communication,” which is incorporated herein by reference in its entirety for all purposes.

### TECHNICAL FIELD

The present disclosure relates to systems and methods for updating and/or reconciling standardized data based on an automatically generated notification.

### BACKGROUND

Due to the rapid rate at which data is being collected, analyzed, and used to solve problems in multiple industries, there is a need for database systems, architectures, and applications that provide seamless mechanisms for receiving data from a plurality of sources, meaningfully aggregate the received data in a data structure that facilitates efficient execution of diligence operations on the received and aggregated data to transform the data into useful information for use by client systems, and securely transmit the transformed data to the client systems for additional validation and/or further instructions. More importantly, there is a need for database systems, architectures, and applications that can reconcile previously received, aggregated and transformed data with newly received aggregated data to facilitate optimal analysis of data directed to health applications, agriculture applications, education applications, government applications, defense applications, etc.

### SUMMARY

A method, system, and computer program product for updating standardized first data based on an automatically generated notification are disclosed. According to one embodiment, the method comprises receiving, at one or more servers, first data from one or more data sources such that the first data includes non-standardized data. The one or more servers may process the first data by converting the first data into standardized first data. The standardized first data may comprise data that has been formatted: to remove at least one discrepancy within the first data; or to enable a compatibility of the first data for storage within the database. In some embodiments, a database associated with the one or more servers may store the standardized first data. A first query may be generated at the one or more servers such that the first query is based on a query language compatible with the database and executable instructions for performing at least one operation within the database based on at least one of a first parameter associated with the standardized first data, a second parameter associated with the database, or a third parameter associated with the first query. The method may further comprise executing, at the one or more servers, the first query including searching the database based on the at least one of the first parameter, the second parameter, or the third parameter. The method may also comprise determining, at the one or more servers, a first result of the first query wherein: the first result of the first query may identify or comprise second data; the second data fails to satisfy at least one criteria of the first query; and the at least one criteria is based on at least one of the first parameter, the second parameter, or the third parameter. According to one embodiment, the method comprises automatically generating, at the one or more servers, a notification that comprises an identifier for flagging that the second data failed to meet the at least one criteria of the first query. Moreover, the method comprises transmitting, from the one or more servers to a first computing device, the notification and receiving, at the one or more servers and from the first computing device, a first user input. In addition, the method comprises updating or reconciling, at the database of the one or more servers, the standardized first data based on the first user input and the result of the first query.

These and other implementations may each optionally include one or more of the following features. The database is a metadata-driven database having a data structure that is queried using a clinical query language (CQL) according to some embodiments. Additionally, a manifest file describing at least one data element of the first data may be used to execute one or more of interpreting a structure of the first data prior to processing the first data; or determining one or more keys associated with the first data such that the one or more keys are used to transform one or more properties of the first data. It is appreciated that the one or more keys associated with the manifest file may also facilitate mapping of the one or more properties of the first data to one or more of: a data structure associated with the database; or a data format associated with the database. In some embodiments, the manifest file indicates at least one of source information associated with the first data; a data type associated with the first data; a format associated with the first data; and one or more data values associated with the first data. Furthermore, the data type indicates one or more precision properties associated with the received first data such that the data format indicates one or more configurable display properties associated with the first data. In some embodiments, the manifest file comprises or is based on a data structure for interpreting the first data for storage within the database.

In some embodiments, reconciling the standardized first data can comprise: generating an export definition for the first data; and enabling data compatibility of the first data for use on the first computing device based on the export definition. In other embodiments, reconciling the standardized first data comprises generating an export definition for the first data and generating, based on the export definition, a specification of a data format, a data structure, or a visualization type for presenting one or more of the notification, the standardized data, or the second data on a display device. In one embodiment, reconciling the standardized first data comprises: generating, based on the export definition, a first consistency report for the first data; or generating, based on the export definition, a second consistency report indicating a change to the first data.

In some embodiments, the first query comprises one or more checks on data within the database. The first query may also be associated with a plurality of criteria including the at least one criteria, the plurality of criteria including one or more of a data similarity property check comprised the one or more checks; an out-of-range property value check comprised in the one or more checks; a data duplication property check comprised in the one or more checks; or a data security property check comprised in the one or more checks. In addition, one or more keys associated with the first data may facilitate mapping of the one or more properties of the first data to one or more of a data structure associated with the database; or a data format associated with the database. In some embodiments, the first data comprises a file that is loaded into a data lake associated with the database and with which the database communicates via an application programming interface, the data lake comprising a plurality of raw unprocessed data from the one or more data sources or from a source or server distinct from the one or more data sources. In one embodiment, one or more of the first parameter, or the second parameter, or the third parameter is associated with or comprises one of a data status identifier; a data location identifier; a data discrepancy identifier; or a data flag identifier.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion. Further, some components may be omitted in certain figures for clarity of discussion.

FIG. 1A illustrates an example high level block diagram of a data management architecture wherein the present technology may be implemented according to some embodiments of the present invention.

FIG. 1B illustrates an example block diagram of a computing device according to some embodiments of the present invention.

FIG. 1C illustrates an example high level block diagram of the data management server according to some embodiments of the present invention.

FIG. 2 is a functional block diagram of a computing environment, in accordance with some embodiments of this disclosure.

FIG. 3 illustrates an example operations flow executed on a plurality of data received from multiple sources, according to some embodiments of this disclosure.

FIGS. 4A-4B respectively show a first and a second exemplary graphical displays within a portal for interaction by users to validate aggregated and transformed data, according to some embodiments of this disclosure.

FIG. 5 shows a third exemplary graphical display within the portal for interaction by users, according to some embodiments of this disclosure.

FIG. 6 shows a fourth exemplary graphical display within the portal for interaction by users, according to some embodiments of this disclosure.

FIG. 7 shows a fifth exemplary graphical display within the portal for interaction by users, according to some embodiments of this disclosure.

FIG. 8 shows a sixth exemplary graphical display within the portal for interaction by users, according to some embodiments of this disclosure.

FIG. 9 shows a seventh exemplary graphical display within the portal for interaction by users, according to some embodiments of this disclosure.

FIG. 10 shows an eighth exemplary graphical display within the portal for interaction by users, according to some embodiments of this disclosure.

FIG. 11 shows a ninth exemplary graphical display within the portal for interaction by users, according to some embodiments of this disclosure.

FIG. 12 shows a tenth exemplary graphical display within the portal for interaction by users, according to some embodiments of this disclosure.

FIG. 13 shows an eleventh exemplary graphical display within the portal for interaction by users, according to some embodiments of this disclosure.

FIG. 14 shows an exemplary flowchart for standardizing data and updating/reconciling standardized data based on an automatically generated notification.

Although similar reference numbers may be used to refer to similar elements for convenience, it can be appreciated that each of the various example embodiments may be considered to be distinct variations. As used in this disclosure, the terms “embodiment” and “example embodiment” do not necessarily refer to a single embodiment, although it may, and various example embodiments may be readily combined and interchanged, without departing from the scope or spirit of the present disclosure. Furthermore, the terminology as used herein is for the purpose of describing example embodiments only, and are not intended to be limitations. In this respect, as used herein, the term “in” may include “in” and “on,” and the terms “a,” “an” and “the” may include singular and plural references. Furthermore, as used herein, the term “by” may also mean “from,” depending on the context. Furthermore, as used herein, the term “if” may also mean “when” or “upon,” depending on the context. Furthermore, as used herein, the words “and/or” may refer to and encompass any and all possible combinations of one or more of the associated listed items.

### DETAILED DESCRIPTION

System Environment

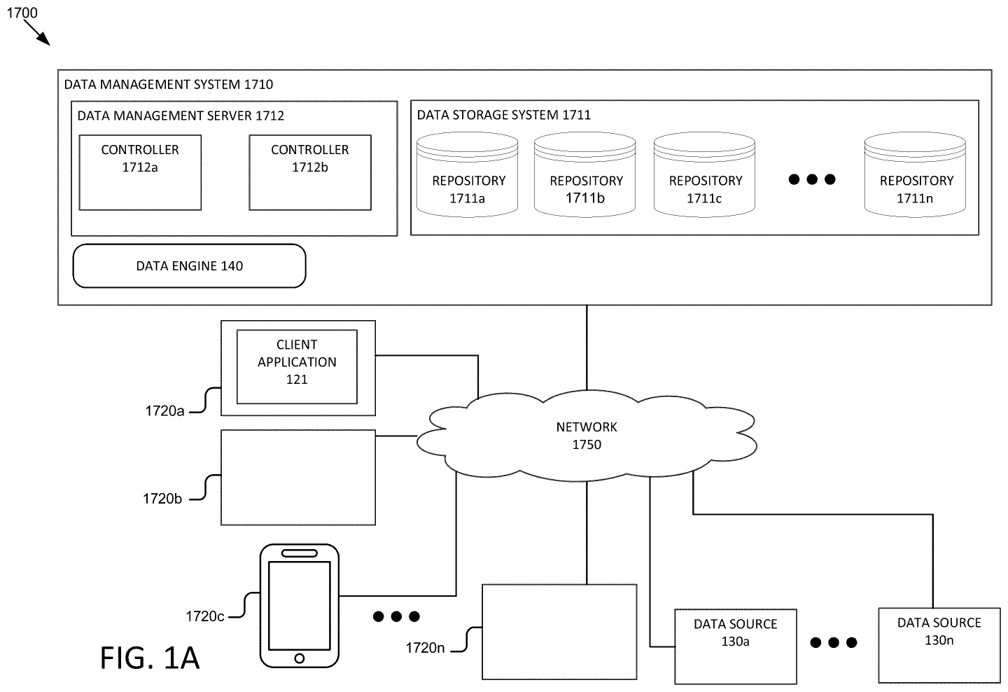

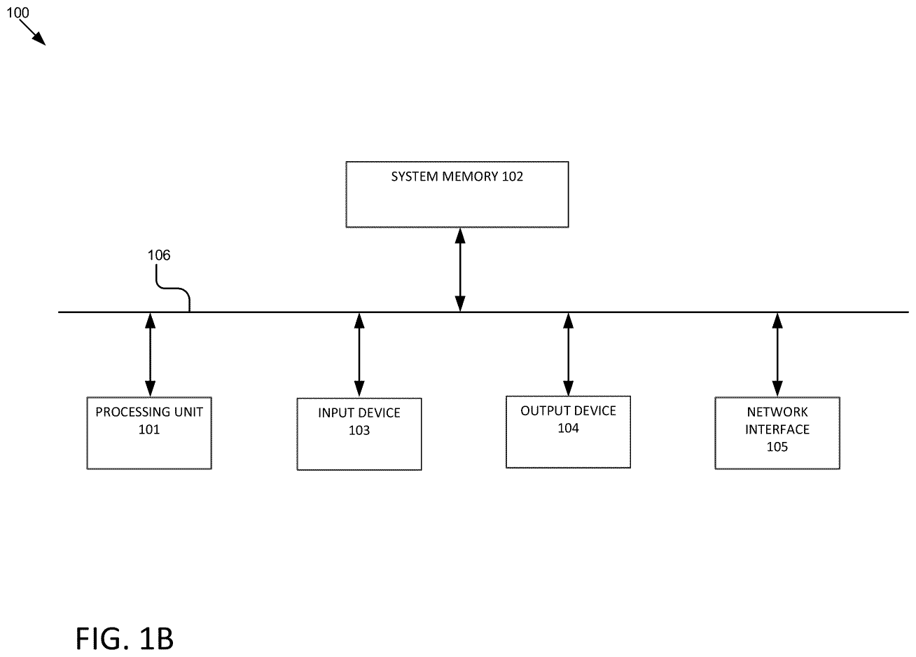

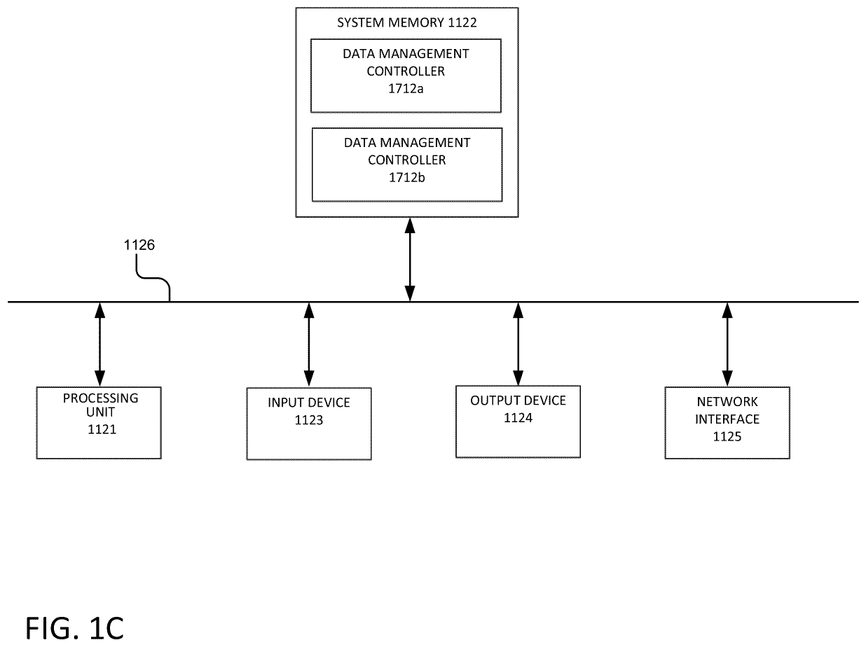

FIG. 1A illustrates an example high level block diagram of a data management architecture 1700 wherein the present invention may be implemented. As shown, the architecture 1700 may include a data management system 1710 and a plurality of user computing devices 1720a, 1720b, . . . 1720n, coupled to each other via a network 1750. The data management system 1710 may include a data storage system 1711 and a data management server 1712. The data storage system 1711 may have two or more repositories, e.g., 1711a, 1711b, 1711c, . . . and 1711n. The network 1750 may include one or more types of communication networks, e.g., a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

The user computing devices 1720a-1720n may be any machine or system that is used by a user to access the data management system 1710 via the network 1750, and may be any commercially available computing devices including laptop computers, desktop computers, mobile phones, smart phones, tablet computers, netbooks, and personal digital assistants (PDAs). A client application 121 may run from a user computing device, e.g., 1720a, and access data in the data management system 1710 via the network 1750.

The data storage system 1711 may store data that client applications (e.g., 121) in user computing devices 1720a-1720n may access and may be any commercially available storage devices. Each content repository (e.g., 1711a, 1711b or 1711n) may store a specific category of data, and allow users to interact with its data in a specific business context. It should be appreciated that content repositories may be separate logic sections in a same storage device.

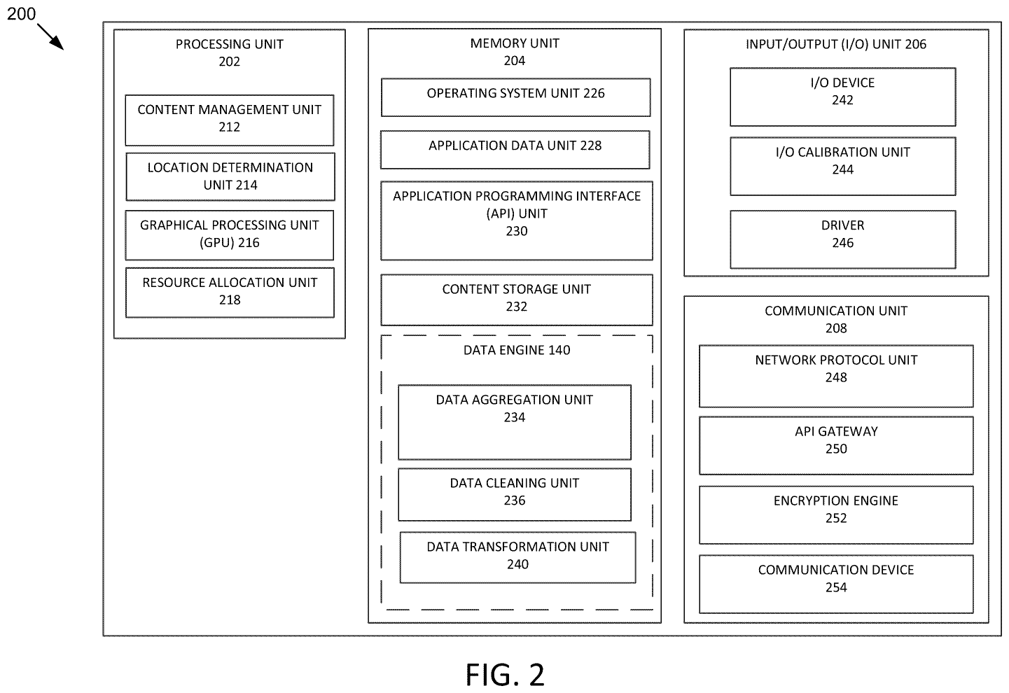

The data management server 1712 is typically a remote computer system accessible over a remote or local network, such as the network 1750. The data management server 1712 may store a data management controller 1712a and a data collection controller 1712b for controlling management and collection of the data. The data management server 1712 could be any commercially available computing devices. Although only one server is shown, it should be appreciated that the data management system 1710 may have a plurality of servers and the controllers 1712a and 1712b may be in separate servers. A client application (e.g., 121) process may be active on one or more user computing devices 1720a-1720n. The corresponding server process may be active on the data management server 1712. The client application process and the corresponding server process may communicate with each other over the network 1750, thus providing distributed functionality and allowing multiple client applications to take advantage of the information-gathering capabilities of the data management system 1710. Moreover, the data engine 140 shown within the data management system 1710 may include one or more units, including a data aggregation unit 234, a data cleaning unit 236, and a data transformation unit 240. These and other aspects are further discussed below in association with FIG. 2.

In one implementation, the architecture 1700 may be used for collecting and managing data, e.g., trial data. In some embodiments, a trial as described in this disclosure may refer to a clinical trial. A first repository (e.g., 1711a) may be used by a first sponsor (e.g., a pharmaceutical company) to store a first study design received from a first user computing device (e.g., 1720a). The first study design may define the infrastructure and lifecycle of the study, and may comprise rules (e.g., for queries, derived values, notifications and displaying events, forms and items), a casebook (i.e., a doctor's binder), event groups, events (e.g., subject visits), forms which comprise segregate sections and fields, item groups and items. In one example, a study design may define a particular study, i.e., each subject may have ten visits, and each visit may have three forms. There may be a workflow associated with each visit, e.g., what needs to be done at each visit. In some embodiments, a subject may comprise or refer to one or more patients.

In one implementation, the first study design may be stored as definition objects in the first repository 1711a, specifying what is required to happen on each site during the study. The first repository 1711a may also store electronic records of the first study. In one implementation, the electronic records may be electronic data capture (EDC) data. Trial source data (e.g., associated with a subject) may be captured at the user computing devices, and the aggregated and obfuscated data may be stored as EDC data in the first repository 1711a. The data management system 1710 may have an interface for receiving EDC data collected in trials and a reporting tool for analysis of the EDC data.

The second repository 1711b may be used by a first site (e.g., a hospital) of the first study to store trial source data from a second user computing device (e.g., 1720b), and a third repository (e.g., 1711c) may be used by a second site of the first study to store trial source data from a third user computing device (e.g., 1720c). The trial source data (e.g., three blood pressure values of a subject taken during one visit) in the second repository 1711b may be converted to EDC data (e.g., the average of the three blood pressure values) automatically, and then stored in the first repository 1711a as EDC data. Similarly, the trial source data in the third repository 1711c may be converted to EDC data automatically, and then stored in the first repository 1711a as EDC data. In one implementation, the trial source data may be converted to the EDC data at the client application 121, and the EDC data is transmitted to the data management server 1712. In one implementation, the trial source data may be transmitted to the repository 1711b or 1711c via the data management server 1712, and converted to the EDC data at the data management server 1712. The EDC data is then stored in the repository 1711a. Data in the second repository 1711b and the third repository 1711c may be synchronized with that in the first repository 1711a regularly or from time to time when new data entries are received from user computing devices. The first study design may be transmitted to the second repository 1711b and the third repository 1711c. The second repository and the third repository may be synchronized with the first repository for updates to the first study design.

In one implementation, the data management system 1710 may be a multi-tenant system where various elements of hardware and software may be shared by one or more customers. For instance, a server may simultaneously process requests from a plurality of customers (e.g., sponsors, sites, etc.), and the data storage system 1711 may store content for a plurality of customers (e.g., sponsors, sites, etc.). In a multi-tenant system, a user is typically associated with a particular customer. In one example, a user could be an employee of one of a number of pharmaceutical companies or trial sites which are tenants, or customers, of the data management system 1710.

In one embodiment, the data management system 1710 may run on a cloud computing platform. Users can access content on the cloud independently by using a virtual machine image, or purchasing access to a service maintained by a cloud database provider.

In one embodiment, the data management system 1710 may be provided as Software as a Service (“SaaS”) to allow users to access the data management system 1710 with a thin client.

Data sources 130a . . . 130n may be configured to transmit and/or receive data to and from the data management system 1710. In particular, the data from the data sources 130a . . . 130n may include data from a plurality of different sources that generate data in similar and/or in dissimilar formats. It is appreciated that the data from one or more of the data sources 130a . . . 130n may include data from one or more servers associated with medical institutions, government institutions, educational institutions, agricultural agencies, defense contractor institutions, etc., according to some embodiments. For example, the data from the one or more of the data sources 130a . . . 130n may include data from one or more servers associated with medical facilities including laboratories, research (e.g., medical research) institutions, hospitals, and/or clinics and may comprise: numerical information representing vital signs like heart rate, respiratory rate, and patient temperature, or the like; diagnostic-related information such as laboratory test results from blood tests, genetic tests, culture results, and so on; and treatment information such as patient medication data, mediation dosage data, mediation intake frequency data, etc. In some cases, the data from the data sources 130a . . . 130n may include medical imagery data such as x-rays and magnetic resonant imaging (MRI) data of a patient. The data from the data sources 130a . . . 130n may also include biographic data of a patient such as patient name, patient age, date of birth of patient, biometric data of patient, etc. Moreover, the data from the data sources 130a . . . 130n may also include administrative data like non-clinical research data focused on record-keeping surrounding a service such as hospital discharge information. This can be part of an electronic health record as well. The data from the data sources 130a . . . 130n may be associated with patient and/or disease registries, which are systems that help collect and track clinical information of defined patient populations. It is also appreciated that the data from the one or more of the data sources 130a . . . 130n may be representative data such as a symbol, placeholder, or other identifying character that represents data in similar and/or in dissimilar formats such that the content repository 113 may interpret the representative data to determine the data it represents.

FIG. 1B illustrates an example block diagram of a computing device 100 which can be used as the user computing devices 1720a-1720n, and the data management server 1712 in FIG. 1A. The computing device 100 is only one example of a suitable computing environment and is not intended to suggest any limitation as to scope of use or functionality. The computing device 100 may include a processing unit 101, a system memory 102, an input device 103, an output device 104, a network interface 105 and a system bus 106 that couples these components to each other.

The processing unit 101 may be configured to execute computer instructions that are stored in a computer-readable medium, for example, the system memory 102. The processing unit 101 may be a central processing unit (CPU).

The system memory 102 typically includes a variety of computer readable media which may be any available media accessible by the processing unit 101. For instance, the system memory 102 may include computer storage media in the form of volatile and/or nonvolatile memory such as read only memory (ROM) and/or random access memory (RAM). By way of example, but not limitation, the system memory 102 may store instructions and data, e.g., an operating system, program modules, various application programs, and program data.

A user can enter commands and information to the computing device 100 through the input device 103. The input device 103 may be, e.g., a keyboard, a touchscreen input device, a touch pad, a mouse, a microphone, and/or a pen.

The computing device 100 may provide its output via the output device 104 which may be, e.g., a monitor or other type of display device, a speaker, or a printer.

The computing device 100, through the network interface 105, may operate in a networked or distributed environment using logical connections to one or more other computing devices, which may be a personal computer, a server, a router, a network PC, a peer device, a smart phone, or any other media consumption or transmission device, and may include any or all of the elements described above. The logical connections may include a network (e.g., the network 1750) and/or buses. The network interface 105 may be configured to allow the computing device 100 to transmit and receive data in a network, for example, the network 1750. The network interface 105 may include one or more network interface cards (NICs).

FIG. 1C illustrates an example high level block diagram of the data management server 1712 according to one embodiment of the present disclosure. The data management server 1712 may be implemented by the computing device 100, and may have a processing unit 1121, a system memory 1122, an input device 1123, an output device 1124, and a network interface 1125, coupled to each other via a system bus 1126. The system memory 1122 may store a data management controller 1712a and/or a data collection controller 1712b.

In one implementation, the data management controller 1712a may be a Java application. A sponsor user may design a study (e.g., a clinical study) via the data management controller 1712a and store the study design as definition objects in a repository (e.g., 1711a). A study design may have multiple elements, including a casebook, groups, events (e.g., subject visits), and forms which include sections, item groups, items, and fields to be filled out.

In one example, a trial is designed to evaluate subject response to a blood pressure medication. Participants on the medication may visit a trial site three times a week for consecutive six weeks. A workflow may be designed for each visit, and may include forms to be filled out, and measurements to be taken. In one example, a participant's blood pressure may be measured three times during each visit, stored in the data storage system (e.g., the repository 1711b) as trial source data, and synchronized with other repositories in the data storage system 1711 (e.g., the repository 1711a for the sponsor). In one implementation, only aggregated and obfuscated data, without subject defining information, are sent to the sponsor repository 1711a and stored there as the EDC data.

A study design may have its own lifecycle. Once a sponsor completes a study design, a workflow may be executed to publish the study design to the participating trial sites (e.g., by storing the study design in trial site repositories 1711b and 1711c) and the trial may enter its execution stage. If the study design is amended during the execution stage, the updates may be sent to the participating trial sites (e.g., by synchronizing the updates down to the trial site repositories 1711b and 1711c) for them to follow.

FIG. 2 illustrates an exemplary functional diagram of a computing environment 200, according to some embodiments of this disclosure, for performing the operations described herein. It is appreciated that the computing environment 200 may be implemented in one or more elements of the data management architecture 1700, such as the data storage system 1711, the data management server 1712, the data sources 130a . . . 130n, the network 1750, or the repositories 1711a . . . 1711n. As seen in FIG. 2, the computing environment 200 may include a processing unit 202, a memory unit 204, an I/O unit 206, and a communication unit 208. The processing unit 202, the memory unit 204, the I/O unit 206, and the communication unit 208 may include one or more subunits for performing operations described herein. Additionally, each unit and/or subunit may be operatively and/or otherwise communicatively coupled with each other so as to facilitate the operations described herein. The computing environment 200 including any of its units and/or subunits may include general hardware, specifically-purposed hardware, and/or software.

The processing unit 202 of the computing environment 200 may control one or more of the memory unit 204, the I/O unit 206, and the communication unit 208, as well as any included subunits, elements, components, devices, and/or functions performed by the memory unit 204, I/O unit 206, and the communication unit 208. The described sub-elements of the computing environment 200 may also be included in similar fashion in any of the other units and/or devices included in the data management architecture 1700 of FIG. 1A. Additionally, any actions described herein as being performed by a processor may be taken by the processing unit 202 of FIG. 2 alone and/or by the processing unit 202 in conjunction with one or more additional processors, units, subunits, elements, components, devices, and/or the like. Further, while one processing unit 202 may be shown in FIG. 2, multiple processing units may be present and/or otherwise included in the computing environment 200 or elsewhere in the overall data management architecture 1700 of FIG. 1A. Thus, while instructions may be described as being executed by the processing unit 202 and/or various subunits of the processing unit 202, the instructions may be executed simultaneously, serially, and/or otherwise by one or multiple processing units 202 on one or more devices.

In some embodiments, the processing unit 202 may be implemented as one or more computer processing unit (CPU) chips and/or graphical processing unit (GPU) chips and may include a hardware device capable of executing computer instructions. The processing unit 202 may execute instructions, codes, computer programs, and/or scripts. The instructions, codes, computer programs, and/or scripts may be received from and/or stored in the memory unit 204, the I/O unit 206, the communication unit 208, subunits, and/or elements of the aforementioned units, other devices, and/or computing environments, and/or the like.

In some embodiments, the processing unit 202 may include, among other elements, subunits such as a content management unit 212, a location determination unit 214, a graphical processing unit (GPU) 216, and a resource allocation unit 218. Each of the aforementioned subunits of the processing unit 202 may be communicatively and/or otherwise operably coupled with each other.

The content management unit 212 may facilitate generation, modification, analysis, transmission, and/or presentation of content. Content may be file content, media content, or any combination thereof. In some instances, content on which the content management unit 212 may operate includes device information, user interface data, images, text, themes, audio files, video files, documents, data from the one or more data sources 130a . . . 130n, etc. Additionally, the content management unit 212 may control the audio-visual environment and/or appearance of application data during execution of various processes. In some embodiments, the content management unit 212 may interface with other third-party content server and/or memory location for execution of its operations.

The location determination unit 214 may facilitate detection, generation, modification, analysis, transmission, and/or presentation of location information. Location information may include global positioning system (GPS) coordinates, an Internet protocol (IP) address, a media access control (MAC) address, geolocation information, a port number, a server number, a proxy name and/or number, device information (e.g., a serial number), an address, a zip code, and/or the like. In some embodiments, the location determination unit 214 may include various sensors, radar, and/or other specifically-purposed hardware elements for the location determination unit 214 to acquire, measure, and/or otherwise transform location information.

The GPU 216 may facilitate generation, modification, analysis, processing, transmission, and/or presentation of content described above, as well as any data described herein. In some embodiments, the GPU 216 may be used to render content for presentation on a computing device via, for example, a web GUI or user portal associated with the data management system 1710. The GPU 216 may also include multiple GPUs and therefore may be configured to perform and/or execute multiple processes in parallel. In some implementations, the GPU 216 may be used in conjunction with the data engine 140, and/or in conjunction with other subunits associated with the memory unit 204, the I/O unit 206, and the communication unit 208.

The resource allocation unit 218 may facilitate the determination, monitoring, analysis, and/or allocation of computing resources throughout the computing environment 200 and/or other computing environments. For example, the computing environment may facilitate a high volume of data (e.g., files and data from the one or more data sources 130a . . . 130n and or data from the data management system 1710), to be processed and analyzed. As such, computing resources of the computing environment 200 used by the processing unit 202, the memory unit 204, the I/O unit 206, and/or the communication unit 208 (and/or any subunit of the aforementioned units) such as processing power, data storage space, network bandwidth, and/or the like may be in high demand at various times during operation. Accordingly, the resource allocation unit 218 may include sensors and/or other specially-purposed hardware for monitoring performance of each unit and/or subunit of the computing environment 200, as well as hardware for responding to the computing resource needs of each unit and/or subunit. In some embodiments, the resource allocation unit 218 may use computing resources of a second computing environment separate and distinct from the computing environment 200 to facilitate a desired operation.

For example, the resource allocation unit 218 may determine a number of simultaneous computing processes and/or requests. The resource allocation unit 218 may also determine that the number of simultaneous computing processes and/or requests meets and/or exceeds a predetermined threshold value. Based on this determination, the resource allocation unit 218 may determine an amount of additional computing resources (e.g., processing power, storage space of a particular non-transitory computer-readable memory medium, network bandwidth, and/or the like) required by the processing unit 202, the memory unit 204, the I/O unit 206, the communication unit 208, and/or any subunit of the aforementioned units for safe and efficient operation of the computing environment while supporting the number of simultaneous computing processes and/or requests. The resource allocation unit 218 may then retrieve, transmit, control, allocate, and/or otherwise distribute determined amount(s) of computing resources to each element (e.g., unit and/or subunit) of the computing environment 200 and/or another computing environment.

In some embodiments, factors affecting the allocation of computing resources by the resource allocation unit 218 may include the number of computing processes and/or requests, a duration of time during which computing resources are required by one or more elements of the computing environment 200, and/or the like. In some implementations, computing resources may be allocated to and/or distributed amongst a plurality of second computing environments included in the computing environment 200 based on one or more factors mentioned above. In some embodiments, the allocation of computing resources of the resource allocation unit 218 may include the resource allocation unit 218 flipping a logic switch, adjusting processing power, adjusting memory size, partitioning a memory element, transmitting data, controlling one or more input and/or output devices, modifying various communication protocols, and/or the like. In some embodiments, the resource allocation unit 218 may facilitate utilization of parallel processing techniques such as dedicating a plurality of GPUs included in the processing unit 202 for running a multitude of processes.

The memory unit 204 may be used for storing, recalling, receiving, transmitting, and/or accessing various files and/or data (e.g., the aforementioned data from the data sources 130a . . . 130n) during operation of computing environment 200. For example, memory unit 204 may be utilized for storing, recalling, and/or updating data associated with, resulting from, and/or generated by any unit, or a combination of units and/or subunits of the computing environment 200. In some embodiments, the memory unit 204 may store instructions, code, and/or data that may be executed by the processing unit 201. For instance, the memory unit 204 may store code that execute operations associated with one or more units and/or one or more subunits of the computing environment 200. For example, the memory unit may store code for the processing unit 202, the I/O unit 206, the communication unit 208, and for itself. In some embodiments, the memory unit may store a specialized database and/or an application programming interface (API) database comprising information (e.g., associated with object-based data or object-related data or object-oriented data and/or content-related data and/or measured data and/or the like) that may be accessed and/or used by applications, units, elements, and/or operating systems of computing devices and/or computing environment 200. In some embodiments, each API database may be associated with a customized physical circuit included in the memory unit 204 and/or the API unit 230. Additionally, each API database may be public and/or private, and so authentication credentials associated with one or more access protocols may be required to access information in the API database.

Memory unit 204 may include various types of data storage media such as solid state storage media, hard disk storage media, virtual storage media, and/or the like. Memory unit 204 may include dedicated hardware elements such as hard drives and/or servers, as well as software elements such as cloud-based storage drives. In some implementations, memory unit 204 may comprise one or more of a random access memory (RAM) device, a dynamic random access memory (DRAM) device, a static random access memory (SRAM) device, flash memory, read only memory (ROM) device, and/or various forms of secondary storage. The RAM device may be used to store volatile data and/or to store instructions that may be executed by the processing unit 202. For example, the instructions stored by the RAM device may be a command, a current operating state of computing environment 200, an intended operating state of computing environment 200, and/or the like. As a further example, data stored in the RAM device of memory unit 204 may include instructions related to various methods and/or functionalities described herein. The ROM device may be a non-volatile memory device that may have a smaller memory capacity than the memory capacity of a secondary storage. The ROM device may be used to store instructions and/or data that may be read during execution of computer instructions. In some embodiments, access to both the RAM device and ROM device may be faster to access than the secondary storage.

Secondary storage may comprise one or more disk drives and/or tape drives and may be used for non-volatile storage of data or as an over-flow data storage device if the RAM device is not large enough to hold all working data. Secondary storage may be used to store programs that may be loaded into the RAM device when such programs are selected for execution. In some embodiments, the memory unit 204 may include one or more databases (e.g., a database associated with one or more repository 1711a . . . 1711n) for storing any data described herein. Additionally or alternatively, one or more secondary databases (e.g., the one or more repository 1711a . . . 1711n discussed with reference to FIG. 1A) located remotely from computing environment 200 may be used and/or accessed by memory unit 204.

Turning back to FIG. 2, the memory unit 204 may include subunits such as an operating system unit 226, an application data unit 228, an application programming interface 230, a content storage unit 232, data engine 140, and a cache storage unit (not shown). Each of the aforementioned subunits of the memory unit 204 may be communicatively and/or otherwise operably coupled with each other and other units and/or subunits of the computing environment 200. It is also noted that the memory unit 204 may include other modules, instructions, or code that facilitate the execution of the techniques described herein. For instance, the memory unit 204 may include one or more modules such as a receiving module, a mapping module, a determining module, a sequencing module, a quantifying module, a resolving module, a parsing module, a visualization module, etc., that comprise instructions executable by one or more computing device processors to accomplish one or more operations provided in this disclosure.

The operating system unit 226 may facilitate deployment, storage, access, execution, and/or utilization of an operating system used by computing environment 200 and/or any other computing environment described herein. In some embodiments, operating system unit 226 may include various hardware and/or software elements that serve as a structural framework for processing unit 202 to execute various operations described herein. Operating system unit 226 may further store various pieces of information and/or data associated with the operation of the operating system and/or computing environment 200 as a whole, such as a status of computing resources (e.g., processing power, memory availability, resource utilization, and/or the like), runtime information, modules to direct execution of operations described herein, user permissions, security credentials, and/or the like.

The application data unit 228 may facilitate deployment, storage, access, execution, and/or utilization of an application and/or data used by computing environment 200 and/or any other computing environment described herein. For example, the application data unit 228 may store any information and/or data associated with an application. Application data unit 228 may further store various pieces of information and/or data associated with the operation of an application and/or computing environment 200 as a whole, such as a status of computing resources (e.g., processing power, memory availability, resource utilization, and/or the like), runtime information, user interfaces, modules to direct execution of operations described herein, user permissions, security credentials, access and processing of data stored in the data management system 1710, and/or the like.

The application programming interface (API) unit 230 may facilitate deployment, storage, access, execution, and/or use of information associated with APIs of computing environment 200 and/or any other computing environment described herein. For example, computing environment 200 may include one or more APIs for various devices, applications, units, subunits, elements, and/or other computing environments to communicate with each other and/or use the same data. Accordingly, API unit 230 may be associated with or otherwise include API databases (e.g., stored in the one or more repositories 1711a . . . 1711n) containing information that may be accessed and/or used by applications, units, subunits, elements, and/or operating systems of other devices and/or computing environments. As previously discussed, each API database may be associated with a customized physical circuit included in memory unit 204 and/or API unit 230. Additionally, each API database may be public and/or private, and so authentication credentials may be required to access information in an API database. In some embodiments, the API unit 230 may facilitate communication between the data management system 1710 and one or more client applications 121.

The content storage unit 232 may facilitate deployment, storage, access, and/or use of information associated with performance of various operations discussed herein. In some embodiments, content storage unit 232 may communicate with content management unit 212 to receive and/or transmit content files (e.g., media content and other data from the data source 130a . . . 130n).

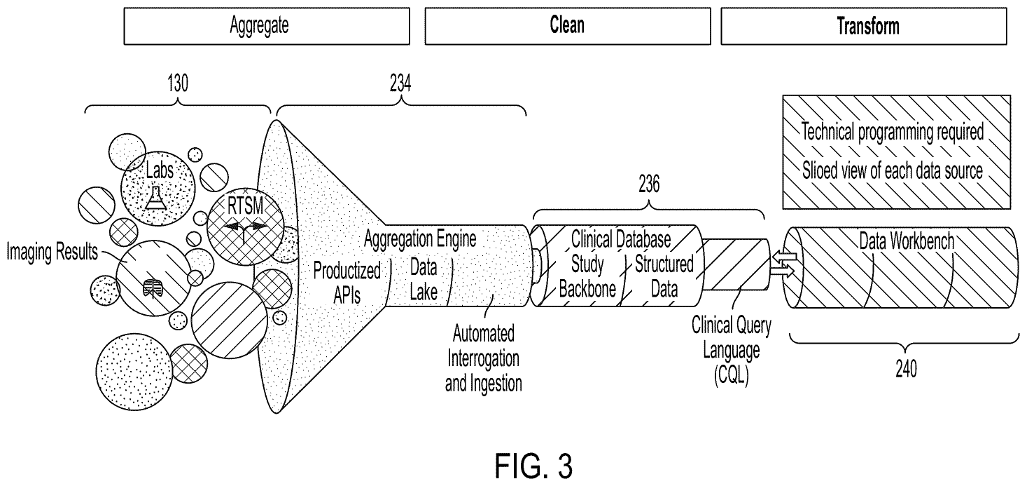

Data engine 140 may include at least a data aggregation unit 234, a data cleaning unit 236, and a data transformation unit 240. According to some embodiments, the data engine 140 may include instructions that facilitate receiving data from a plurality of sources, aggregating the data in a specialized data structure that facilitates efficient real-time execution of diligence and/or reconciliation operations to transform the received and aggregated data and thereby generate a report indicative of whether there are one or more inconsistencies and/or validation issues associated with the aggregated data. In some implementations, the diligence and/or reconciliation operations may include automatic real-time operations that execute one or more checks or queries on the aggregated data to determine whether the aggregated data is accurate. According to some implementations, one or more notifications may be transmitted to stake-holders associated with the one or more client applications 121 based on the generated report responsive to the diligence and/or reconciliation operations. It is appreciated that the data engine may comprise multiple engines such that there is at least one engine for data ingestion and data export. In particular, the data engine may comprise one or more engines such that each engine comprised in the one or more engines may include multiple units such as the data aggregation unit 234, the data cleaning unit 236, etc. These and other aspects are further discussed in association with FIG. 3.

The cache storage unit (not shown) of the memory unit 204 may facilitate short-term deployment, storage, access, analysis, and/or utilization of data (e.g., data from the one or more data sources 130a . . . 130n). In some embodiments, the cache storage unit may serve as a short-term storage location for data so that the data stored in cache storage unit may be accessed quickly. In some instances, the cache storage unit may include RAM devices and/or other storage media types for quick recall of stored data. The cache storage unit may include a partitioned portion of storage media included in memory unit 204.

The I/O unit 206 may include hardware and/or software elements for the computing environment 200 to receive, transmit, and/or present information useful for performing diligence and/or reconciliation operations and/or other processes described herein. As described herein, I/O unit 206 may include subunits such as an I/O device 242, an I/O calibration unit 244, and/or driver 246.

The I/O device 242 may facilitate receipt, transmission, processing, presentation, display, input, and/or output of information as a result of executed processes described herein. In some embodiments, the I/O device 242 may include a plurality of I/O devices. In some embodiments, I/O device 242 may include a variety of elements that enable a user to interface with computing environment 200. For example, I/O device 242 may include a keyboard, a touchscreen, a button, a sensor, a biometric scanner, a laser, a microphone, a camera, and/or another element for receiving and/or collecting input from a user. Additionally and/or alternatively, I/O device 242 may include a display, a screen, a sensor, a vibration mechanism, a light emitting diode (LED), a speaker, a radio frequency identification (RFID) scanner, and/or another element for presenting and/or otherwise outputting data to a user.

The I/O calibration unit 244 may facilitate the calibration of the I/O device 242. For example, I/O calibration unit 244 may detect and/or determine one or more settings of I/O device 242, and then adjust or otherwise modify settings so that the I/O device 242 may operate more efficiently.

In some embodiments, I/O calibration unit 244 may use a driver 246 (or multiple drivers) to calibrate I/O device 242. For example, driver 246 may include software that is to be installed by I/O calibration unit 244 so that an element of computing environment 200 (or an element of another computing environment) may recognize and/or integrate with I/O device 242 for the operations described herein.

The communication unit 208 may facilitate establishment, maintenance, monitoring, and/or termination of communications between computing environment 200 and other computing environments, third party server systems, and/or the like (e.g., between the data management system 1710, the client applications 121, and/or the data sources 130a . . . 130n). Communication unit 208 may also facilitate internal communications between various elements (e.g., units and/or subunits) of computing environment 200. In some embodiments, communication unit 208 may include a network protocol unit 248, an API gateway 250, an encryption engine 252, and/or a communication device 254. Communication unit 208 may include hardware and/or software elements.

The network protocol unit 248 may facilitate establishment, maintenance, and/or termination of a communication connection for computing environment 200 by way of a network (e.g., network 1750). For example, network protocol unit 248 may detect and/or define a communication protocol required by a particular network and/or network type. Communication protocols used by network protocol unit 248 may include Wi-Fi protocols, Li-Fi protocols, cellular data network protocols, Bluetooth® protocols, WiMAX protocols, Ethernet protocols, powerline communication (PLC) protocols, and/or the like. In some embodiments, facilitation of communication for computing environment 200 may include transforming and/or translating data from being compatible with a first communication protocol to being compatible with a second communication protocol. In some embodiments, network protocol unit 248 may determine and/or monitor an amount of data traffic to consequently determine which particular network protocol may be used for establishing a secure communication connection, transmitting data, and/or performing operations and/or processes described herein.

The application programming interface (API) gateway 250 may allow other devices and/or computing environments to access API unit 230 of memory unit 204 of computing environment 200. For example, a client application 121 may access API unit 230 of computing environment 200 via API gateway 250. In some embodiments, API gateway 250 may be required to validate user credentials associated with a user (e.g., stake-holder) of the client application 121 prior to providing access to API unit 230 to a user. API gateway 250 may include instructions for computing environment 200 to communicate with another device and/or between elements of the computing environment 200.

The encryption engine 252 may facilitate translation, encryption, encoding, decryption, and/or decoding of information received, transmitted, and/or stored by the computing environment 200. Using encryption engine 252, each transmission of data may be encrypted, encoded, and/or translated for security reasons, and any received data may be encrypted, encoded, and/or translated prior to its processing and/or storage. In some embodiments, encryption engine 252 may generate an encryption key, an encoding key, a translation key, and/or the like, which may be transmitted along with any data content.

The communication device 254 may include a variety of hardware and/or software specifically purposed to facilitate communication for computing environment 200. In some embodiments, communication device 254 may include one or more radio transceivers, chips, analog front end (AFE) units, antennas, processing units, memory, other logic, and/or other components to implement communication protocols (wired or wireless) and related functionality for facilitating communication for computing environment 200. Additionally and/or alternatively, communication device 254 may include a modem, a modem bank, an Ethernet device such as a router or switch, a universal serial bus (USB) interface device, a serial interface, a token ring device, a fiber distributed data interface (FDDI) device, a wireless local area network (WLAN) device and/or device component, a radio transceiver device such as code division multiple access (CDMA) device, a global system for mobile communications (GSM) radio transceiver device, a universal mobile telecommunications system (UMTS) radio transceiver device, a long term evolution (LTE) radio transceiver device, a worldwide interoperability for microwave access (WiMAX) device, and/or another device used for communication purposes.

FIG. 3 illustrates an example operations flow executed on a plurality of data received from multiple sources, according to some embodiments of this disclosure. According to one embodiment, an aggregation engine (e.g., aggregation unit 234) may receive a plurality of data from multiple source such as the data sources 130a . . . 130n outlined in FIG. 1A. It is appreciated that the data from one or more of the data sources 130a . . . 130n or from multiple data streams may include data from one or more servers associated with medical institutions, government institutions, educational institutions, agricultural agencies, defense contractor institutions, etc., according to some embodiments. For example, the multiple data streams, feed, or flow into the aggregation engine and may include data from sources such as servers associated with medical facilities, laboratories, research institutions, hospitals, clinics and may comprise: numerical information such as vital signs like heart rate, respiratory rate, and patient temperature, or the like; diagnostic-related information such as laboratory test results from blood tests, genetic tests, culture results, and so on; and treatment information such as patient medication data, mediation dosage data, mediation intake frequency data, etc. In some cases, the data may include medical imagery data such as x-rays and magnetic resonant imaging (MRI) data of a patient. The data may also include biographic data of a patient such as patient name, patient age, date of birth of patient, biometric data of patient, etc. Moreover, the data may also include administrative data like non-clinical research data focused on records surrounding a service such as hospital discharge information. This can be part of an electronic health record according to some embodiments. The data from the data sources 130a . . . 130n may be associated with patient and/or disease registries that help collect and track clinical information of defined patient populations. It is appreciated that the data may include data from government institutions, educational institutions, agricultural agencies, defense contractor institutions, etc., according to some embodiments. Moreover, the data may be received from a combination of institutions as the case may be. According to some embodiments, the data may be directly received from individuals (e.g., patients, clients, etc.) and may be in multiple different formats.

According to one embodiment, the data streams may be continuously received from the multiple sources 130 or streams 130 and may be automatically aggregated. According to one embodiment, aggregating the data may include structuring the received data in a specialized database. In one embodiment, the specialized database may be optimized or otherwise enhanced to store particular types of data for a specific application. For example, the specialized database may include a clinical database configured to store medical data. The specialized database may be configured or otherwise customized to store education data, government agency data, agricultural data, etc., as the case may be. In one embodiment, the specialized database is a metadata-driven database designed to have a study backbone with a data structure that is queried using a clinical query language (CQL). In some embodiments, the specialized database may be a database configured to store data.

For each received data, the aggregation engine 234 may use a manifest file that describes (e.g., describes at least one data element comprised in the received data) or otherwise interprets the structure of the received data. In some embodiments, the manifest file provides a data structure for interpreting the first data for storage within the database. For example, the manifest file may provide information about the source from which the data originated, a type (e.g., a data type indicating precision properties) for the received data, a format for the received data (e.g., a format indicating configurable display properties of the first data), values (e.g. one or more data values) comprised in the received data, etc. In one embodiment, the manifest file may allow the aggregation engine to determine one or more keys associated with each received data which may be used to transform one or more aspects/properties (e.g., keys, formats, etc.) of the received data during the aggregation phase. In some cases, the one or more keys associated with each received data may facilitate, before or after the data transformation, a mapping of the one or more aspects/properties of the received data to data structures, data formats, or other data conventions within the specialized database for efficient querying and data extraction. In some embodiments, the data transformation includes modifying the initial format of the data into a standardized format according to the formatting requirements of the specialized database. It is appreciated that the received data may be ingested by the aggregation engine via one or more APIs such as those discussed above. Moreover, the received data may comprise one or more files that are loaded into a data lake comprising a repository or a plurality of raw unprocessed data from the one or more data sources. In addition, the aforementioned operations of the aggregation engine may be executed on the data in the data lake via an enhanced automated interrogation and ingestion operation that processes the received data for storage in the specialized database.

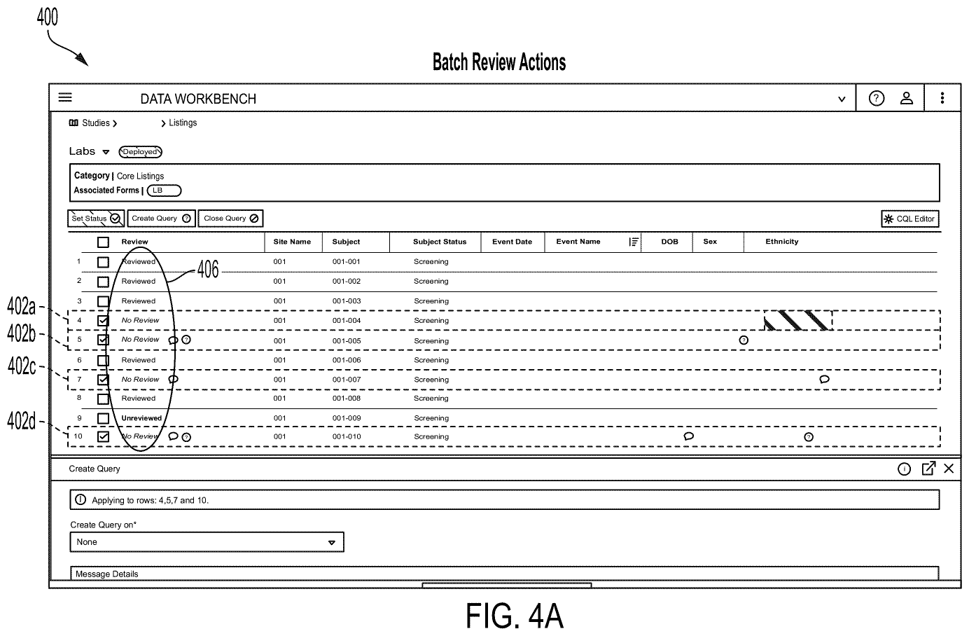

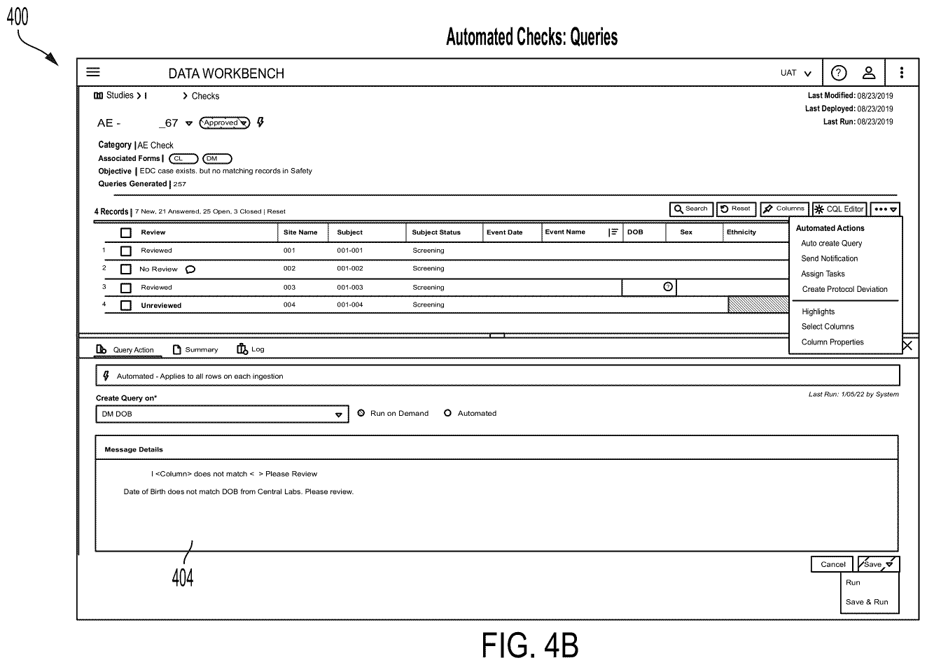

It should be noted that the received data may have all kinds of issues including incompleteness, erroneous values, inconsistent formats, version control problems, duplicate values, inaccurate identifiers, security vulnerabilities, etc. These, among other issues, need to be resolved to ensure the accuracy and integrity of the data stored in the specialized database. According to one embodiment, the specialized database may have an associated workbench or interface that drives the management of the data stored in the specialized database. For example, the specialized database may include a listings and reporting mechanism, a discrepancy management mechanism, and an automated extraction mechanism, all of which allow meaningful interaction with the specialized database. In one embodiment, the listings and reporting mechanism may allow for incremental, single, or batch review of data within the specialized database with automatic, built-in change detection features that indicate any changes to a particular stored data within the specialized database. The discrepancy management mechanism may facilitate the creation and/or execution of queries directed to resolving issues associated with any kind of data stored in the specialized database. Moreover, the discrepancy management mechanism may facilitate generation of query results or extracts from the specialized database automatically or upon demand. Furthermore, the automated extracts mechanism may work in conjunction with the discrepancy management mechanism to generate one or more report, custom extracts, or files that indicate identified data discrepancies, resolved data discrepancies, specifically requested data, stake-holder notifications to take action, etc. The cleaning and data transformation processes, which are respectively executed by the data cleaning unit 236 and the data transformation unit 240, are further discussed in conjunction with FIGS. 4A and 4B.

Prior to the implementation of the instant systems and methods, a data manager had to work with individual data sources in receiving and managing data from said sources. In some cases, the data managers had very limited capacity to parse the received data so as to effectively store the received data and resolve any issues associated with the received data. Moreover, it becomes increasing infeasible for the data manager to effectively analyze batches of data from multiple data sources so as to identify in real-time, or near-real-time, any issues associated with the received data and notify, in real-time, or near-real-time, any stake-holders associated with the data. More importantly, it becomes highly inefficient and rather impossible for the data manager to manually work their way through the volumes of received data, determine the necessary operations that properly store the received data in the specialized database, and execute one or more operations on the received data for analytics and data cleansing purposes as such operations cannot be mentally performed due to both the volumes or batches of data received from the data sources and the effect a single change may have on other data objects that are difficult or impossible to detect and/or track and which are based on a single change in the data. Furthermore, previous techniques often involved expensive manual reviews, complex programming associated with displaying result sets for manual review and constrained listing of results which often do not provide holistic analyses of batch data. The disclosed technology not only resolves these issues but optimizes execution of various data cleaning and analysis operations on received data associated with any particular industry. In particular, the disclosed techniques and systems allow for automated checks and queries that do not require human intervention, that have very reduced code complexity, and that have low cycle times in generating automated checks to provide an increased value to stake-holders in terms of efficiency, accuracy, and timeliness.

As an example, FIG. 4 shows an exemplary portal 400 for interaction by a user of data within the specialized database. In FIG. 4A, the user (e.g., data managers and/or other stake-holders) may be provided with a user interface or portal 400 associated with the workbench of the specialized database which allows the user to select multiple records 402a, 402b, 402c, and 402d (simply referenced as 402) or batches of records 402 within the specialized database for further analysis. The selection of the multiple records 402 may be motivated by a relationship between the multiple records, version data associated with the multiple records, out of range values associated with the multiple records, identifier issues associated with the multiple records, or some other data point of interest to the user. In one embodiment, the multiple records 402 may include similar or dissimilar data types, similar or dissimilar file types, similar or dissimilar object types, etc. Once the records are selected, the workbench of the specialized database may facilitate the execution of one or more queries that can transform the data in the specialized database, test the data in the specialized database, or generate specific data in the specialized database. In some cases, the instructions may include selectable instructions found under “Automated Actions” options included in the portal. The “Automated Actions” options may include instructions such as “Auto create Query,” “Send Notification,” “Assign Tasks,” “Create Protocol Deviation,” “Highlights,” “Select Columns,” and “Column Properties.” Furthermore, the workbench may include or allow access to a repository of queries that facilitate a plurality of automated actions or instructions executed on data within the specialized database.

For example, and as shown in FIG. 4B, the portal may facilitate the execution of custom or automatic queries to the data within the specialized database. In response to executing the custom or automatic queries to the database, the portal 400 may display, in a message window 404, notifications or reports associated with executing the custom or automatic queries on the specialized database. According to some implementations, the custom or automatic queries may include instructions to the specialized database to transform stored data and instructions to the specialized database to retrieve one or more data as the case may be. In the example of FIG. 4B, we see that for selected records 402 (see FIG. 4A), a query to determine the accuracy of the selected data generated a notification in the notification window 404 that indicates that the “Date of Birth does not match DOB from Central Labs. Please review.” Such a notification may be automatically and/or directly sent to all stake-holders associated with the selected records in real-time or near-real-time via electronic communication. The stake holders may in turn respond via an application on their individual computing devices that is associated with the portal with feedback that can either confirm the assessment of the queries, challenge the assessment of the queries, or provide additional information or context that helps to resolve identified issues associated with the selected records. In one embodiment, the portal 400 shown in FIGS. 4A and 4B may facilitate automatic flagging of discrepancies of stored data, automatic execution of one or more queries to identify, confirm, and/or resolve identified discrepancies in the stored data, and automatic closure of queries in response to resolving the identified discrepancies. In one embodiment, the portal 400 of FIGS. 4A and 4B may include one or more flags 406 that indicate that a given set of records have been tested and have passed validation. For example, the portal may include a reviewed or unreviewed flag as shown in FIG. 4 to indicate that a given record has been tested or otherwise reviewed (e.g., reviewed automatically by the workbench) for accuracy. In one embodiment, the one or more flags 406 easily draw the attention of the user to determine which records or data within the specialized database need additional attention for reconciliation purposes.

In some embodiments, the portal, which is driven for example, by the data cleaning unit 236 and/or the data transformation unit 240 of FIG. 2, may provide a mechanism for stake-holders to provide necessary confirmations or configurations that may be used to, for example, format result sets responsive to executing one or more automatic queries, standardize formats of result sets responsive to executing one or more automatic queries, apply value bounds to extracted data, etc. The configuration instructions may also ensure that specific parameters associated with stored data are updated or otherwise transformed based on stake-holder specifications. According to one implementation, the specific parameters may be associated with or comprise one or more of data status identifiers, data type identifiers, data name identifiers, data location identifiers, metadata identifiers, data definition identifiers, data package identifiers, data modification date identifiers, data key identifiers, data source identifiers, data review status identifiers, data discrepancy identifiers, data security identifiers, data format identifiers, data flag identifiers, etc. Moreover, the portal may, in addition, facilitate data tracking to ensure version control of data within the specialized database. According to some implementations, the portal 400 may facilitate the creation of an import definition which leverages the data in the manifest file to appropriately store the received data in specified configurations within the specialized database. In some embodiments, the portal provides an export definition mechanism that allows the stake-holder to determine or otherwise specify various formats and data structures or visualizations for presenting extracted data from the specialized database and/or data (e.g., notification, raw data, and/or standardized data) associated with queries executed on the specialized database, and/or analytics run on data within the specialized database. It is appreciated that these operations may be performed in real-time or near-real-time on a rolling basis.

According to some implementations, the received data is first aggregated, cleaned or otherwise transformed into useful and accurate data that is further analyzed. The portal 400, discussed in conjunction with FIGS. 4A and 4B may facilitate data tracking during the aggregation phase, the cleaning and/or data transformation stage, and the data analysis stage. The stage visibility that the portal 400 allows appropriate application of intelligent and otherwise automated operations to be applied to the received data in order to more accurately advise stake-holders, data managers, and other users on the data stored in the specialized database. Moreover, the portal 400 provides a seamless interface that allows the stake-holders, data-managers, and other users to easily interact with the data stored in the specialized database. In particular, the portal 400 allows a user to easily detect or otherwise be notified of changes to the stored data in the specialized database. This change-detection feature of the portal 400 allows for customized notifications to be sent to stake-holders as and when relevant portions of the data stored within the specialized database are transformed or updated. According to some implementations, an import definition may be synched with a change-detection feature of the portal 400 which in turn may be synched with an export definition to ensure, enable, or generate a first consistency information report for data entering the specialized database, a second consistency information report indicating changes to the data being stored based on the first consistency information report, and/or a third consistency information report of data being exported out of the specialized database based on one or more data received from the one or more data sources. When there is discrepancy or rather, when the import definition is out of synch with the change-detection feature and/or out of synch with the export definition, change-detection operations may be executed to address same. According to some embodiments, a plurality of change-detection operations are executed to resolve identified synchronization issues. For example, change-detection operations may be executed on the import definition to reconcile issues with received data with previous stored data. In addition, change-detection operations may also be executed on an export definition to ensure that new data being exported from the specialized database is consistent with stake-holder or user export specifications.

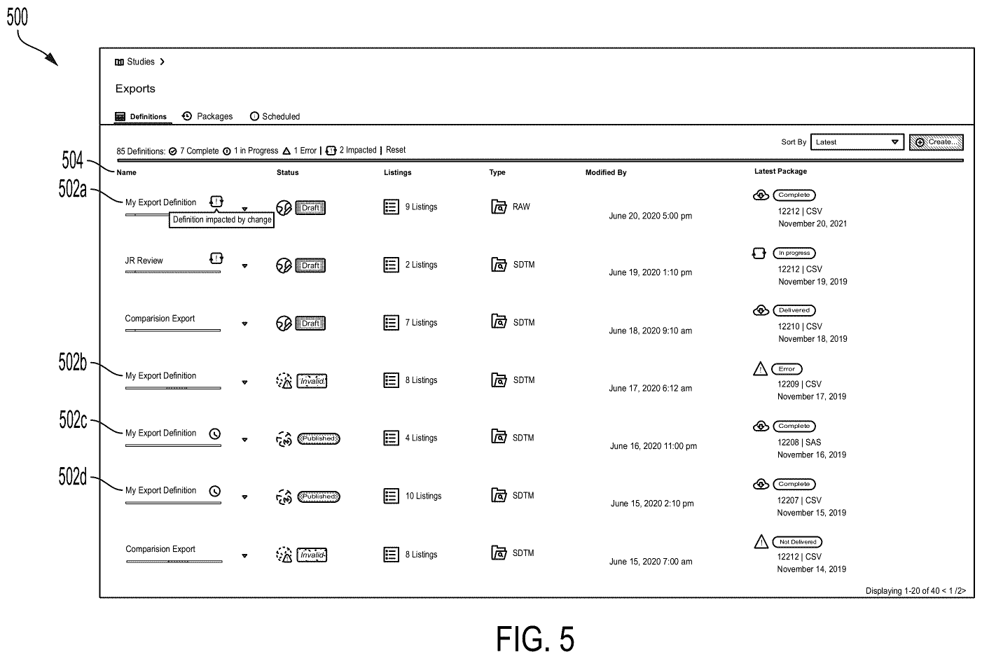

FIG. 5 shows an example graphical display 500 within the portal 400 of the workbench of a plurality of aggregated export definitions 502a, 502b, 502c, and 502d. As can be seen in the figure, each export definition 502 may include an identifier element section 504 that automatically informs a user of any changes to the data within the specialized database that may affect or otherwise impact instructions or specifications based on the export definition 502. In some cases, the identifier element may also flag that the current export definition may differ in several respects (e.g., requested format, requested data values, etc.) from a previous export definition used to access the same or similar data from the specialized database. In addition, the graphical display may include status identifiers, listings identifiers, object type identifiers, identifiers indicating modifiers of the export definition or export definition file, a packages identifier.

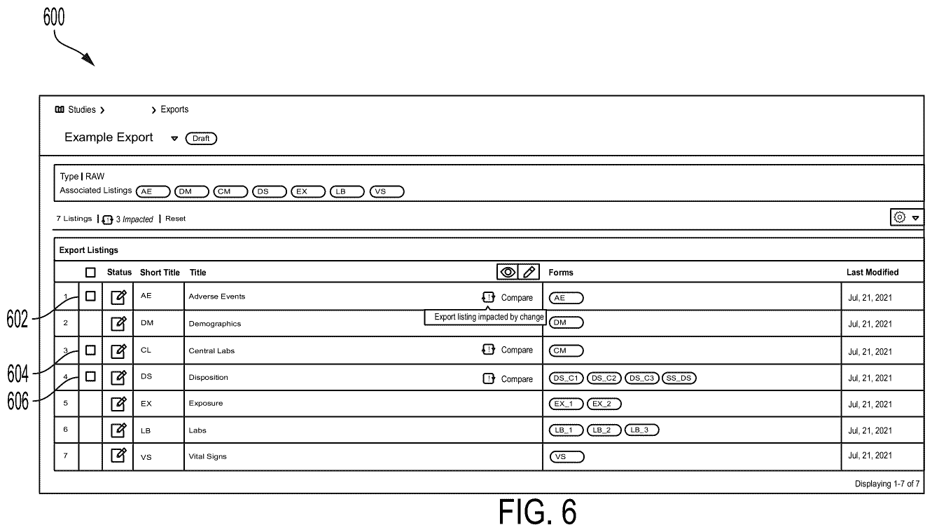

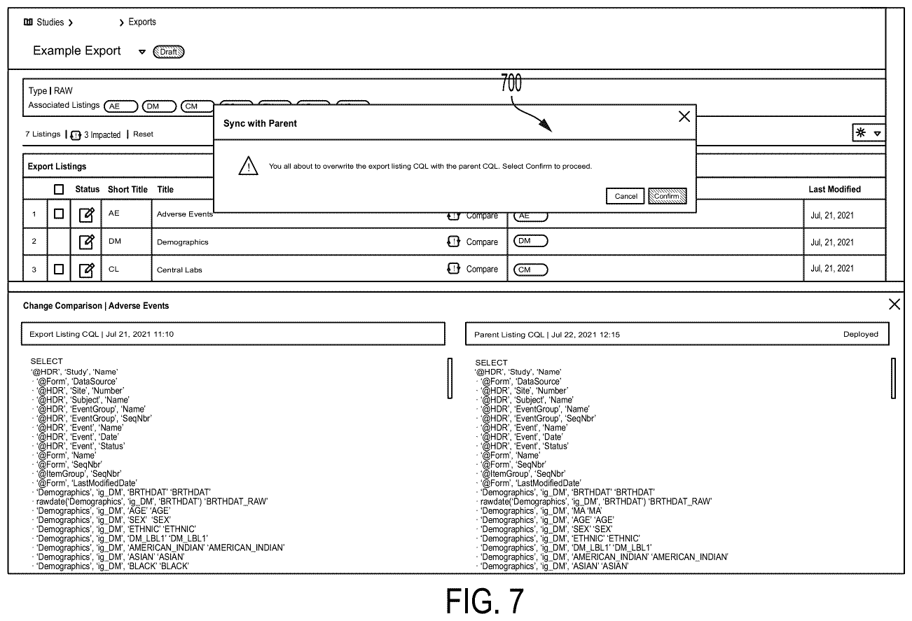

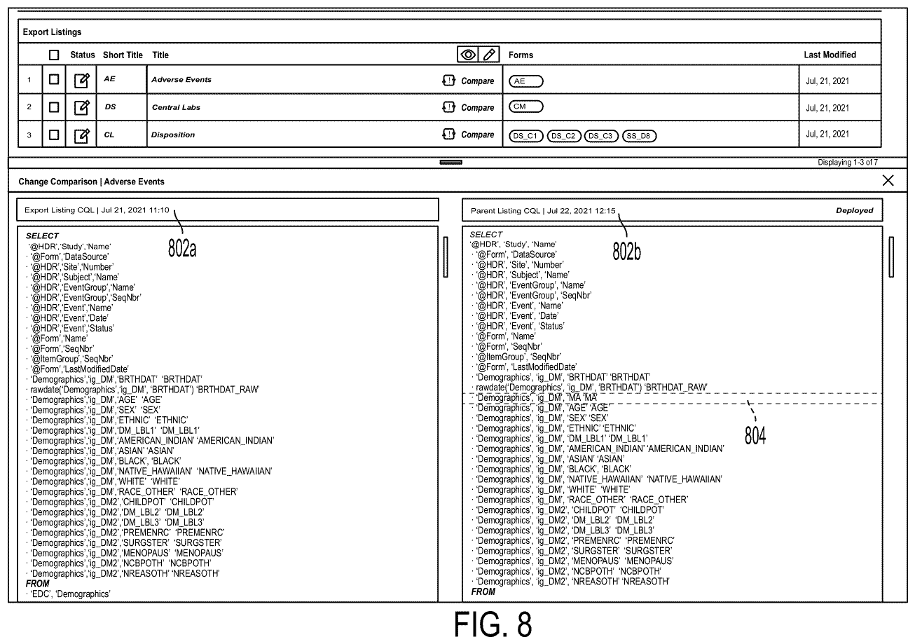

By selecting an export definition identifier (e.g., entries under the export definition identifier 504), for example, a user may be transitioned from the graphical display or interface 500 of FIG. 5 to the graphical interface 600 of FIG. 6. Here, the user is provided a more granular insight into issues flagged for the given export definition. In the example of FIG. 6, listings 1, 3, and 4 (e.g., listings 602, 604, and 606, respectively) of a given data within the specialized database have had changes that impact the export definition in question. These issues can be further assessed by a user if needed. According to some embodiments, prior to the user even accessing the portal to assess issues with, for example, a given export definition, an electronic notification may be sent to the user alerting him or her of the changes to the export definition and should the user desire to further probe into the flagged changes, he or she may resort to using interfaces of the portal such as shown in FIGS. 5 and 6. The export definition issues may be batch selected and the user provided with an option to sync the updated export definition with a parent or previous export definition. The dialogue box shown in FIG. 7 allows the user to make such a determination. According to some embodiments, a user may select a compare display element (e.g., icon) associated with the export definition as shown in FIG. 8. In such cases, a previous export listing may be provided together with a more recent export listing associated with the export definition. In particular, the two listings (previous (808a) and recent (808b)) may be displayed side-by-side as shown in FIG. 8 for evaluation of the user. In some embodiments, an automatic comparison may be run between the two listings with flags for the user to readily identify where the two listings differ. In the example shown in FIG. 8, differences in code associated with the previous and current listings may be identified using, for example, the data engine and options provided to the user to either accept, reject, or modify the code associated with the current listing. In the illustrated example of FIG. 8, the difference may be seen in the more recent listing where there is an inclusion 804 of additional demographics data.

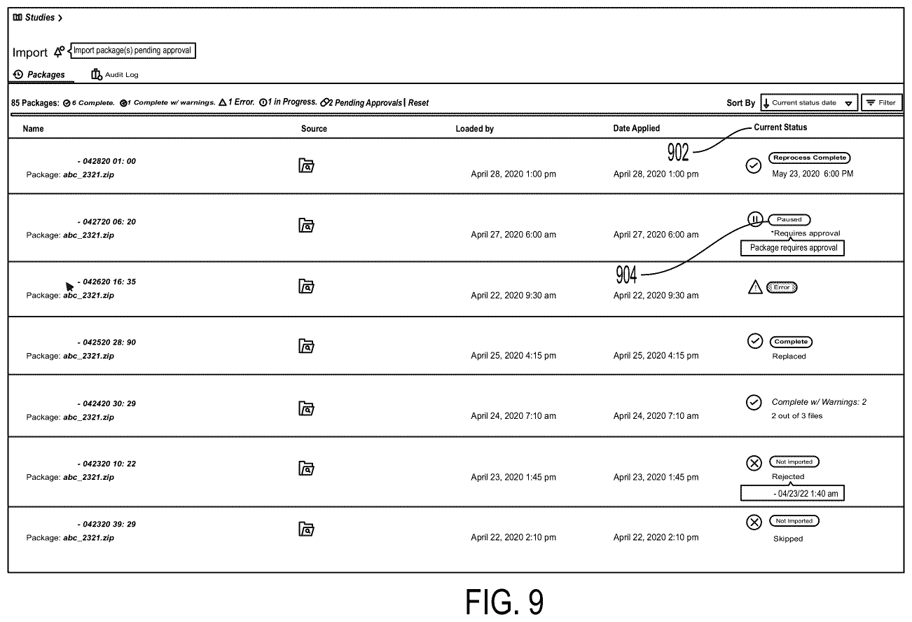

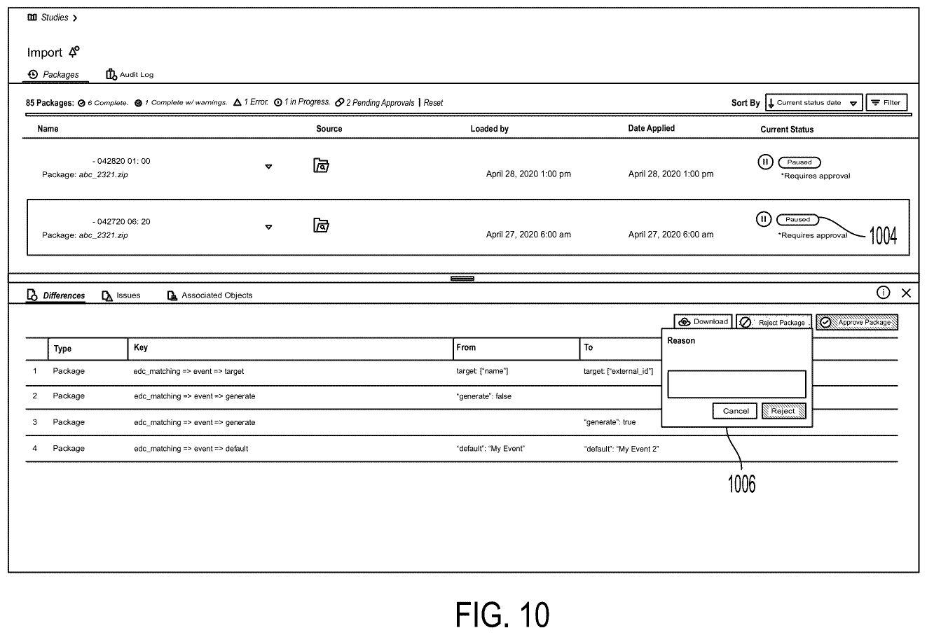

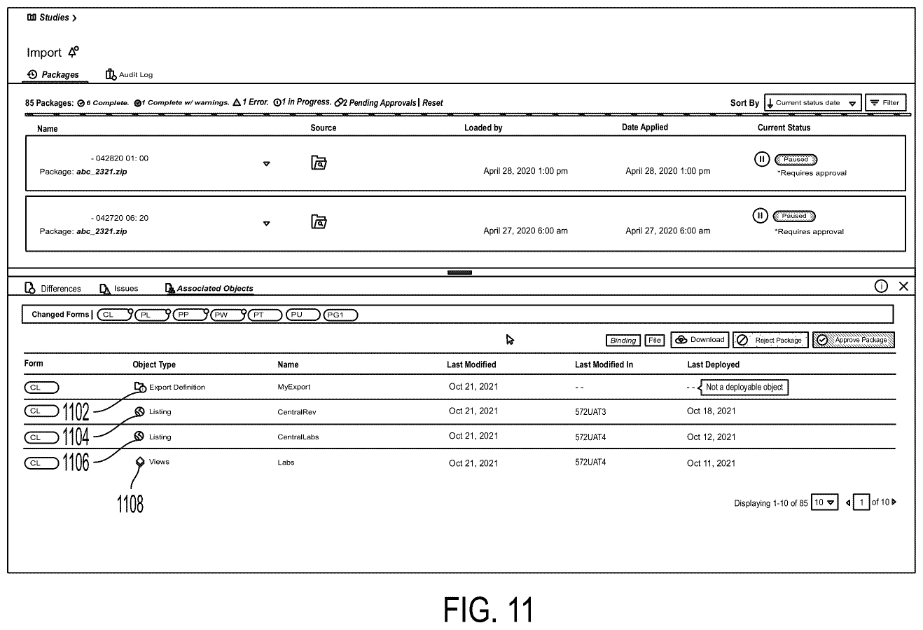

On the data ingestion or reception side, import validation operations may also be executed. As shown in the example of FIG. 9, data from multiple sources may be received and loaded into the specialized database at different times. Each of the loaded data may have an associated status indicator (e.g., entries under the status identifier 902) indicating whether the data has been cleaned, transformed, reconciled, or otherwise processed in some meaningful way. For example, the loaded data may have a paused status 904 that indicates that there is a discrepancy between previously ingested data and the currently ingested data. A user with appropriate credentials to access the paused data may be notified via electronic communication and said user can then access the paused data via the portal of the workbench associated with the data engine to conduct further analyses on the paused data. Some of the actions the user may execute after the analyses include approving the newly loaded data for storage, rejecting the newly loaded data in which case the newly loaded data is discarded, or providing new data to be loaded. For example, and as shown in FIG. 10, the user may select an option on the interface that transitions interface of FIG. 9 to FIG. 10 so as to more clearly identify the reasons why the loaded data has a paused status, flag, or identifier. The user may be provided with options (e.g., option 1006) to either approve or reject packages associated with changes between the previously loaded data and the paused data. FIG. 11 provides a system-wide view of the impacts of the overall changes to the specialized database based on the changes associated with the paused data. In the illustrated example, multiple object types 1102, 1104, 1106, and 1108 with associated names are impacted by the proposed changes that affect the paused data. This effectively informs or notifies the user of the specific necessary changes to make to the data itself or newly received data, to the specialized database, or to client-based systems in order for transformed data from the specialized database to be useable within the specialized database and on said client-based systems. When this is not done, the exportation of data, including to client-based systems, often breaks-down or otherwise crashes when the data to be exported does not match the data in the specialized database or the data received from the specialized database via the web-clients does not match the specific requirements of a client-based system. Thus, an added benefit of the instant application is that it allows for resolution of data discrepancies that would prevent or otherwise harm or delay data exportation and provides valuable insights into how changes associated with high volumes of data for a given industry occur, and how to adapt (automatically or otherwise) data exports or client-based systems to account for said changes and still run effectively without equipment or system malfunctions.

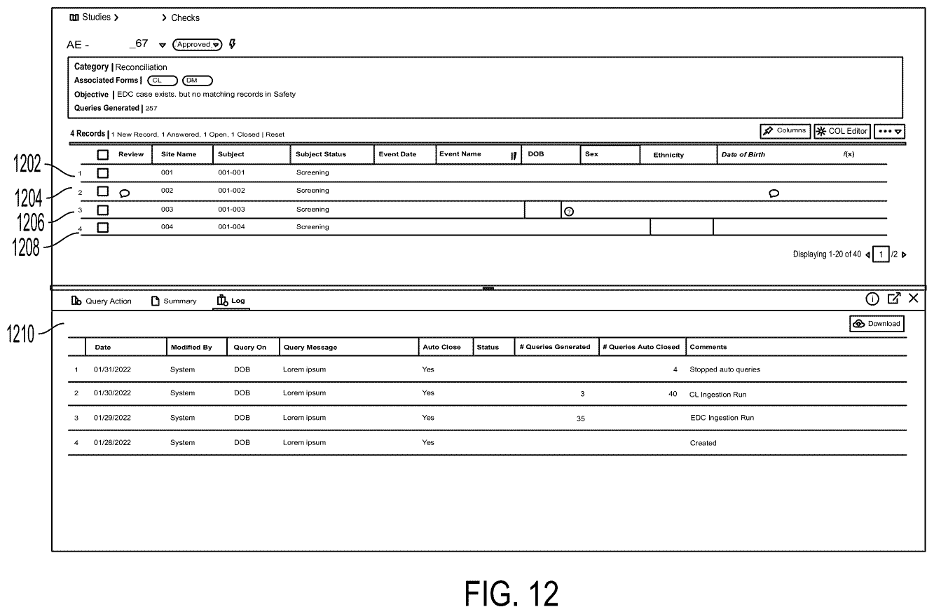

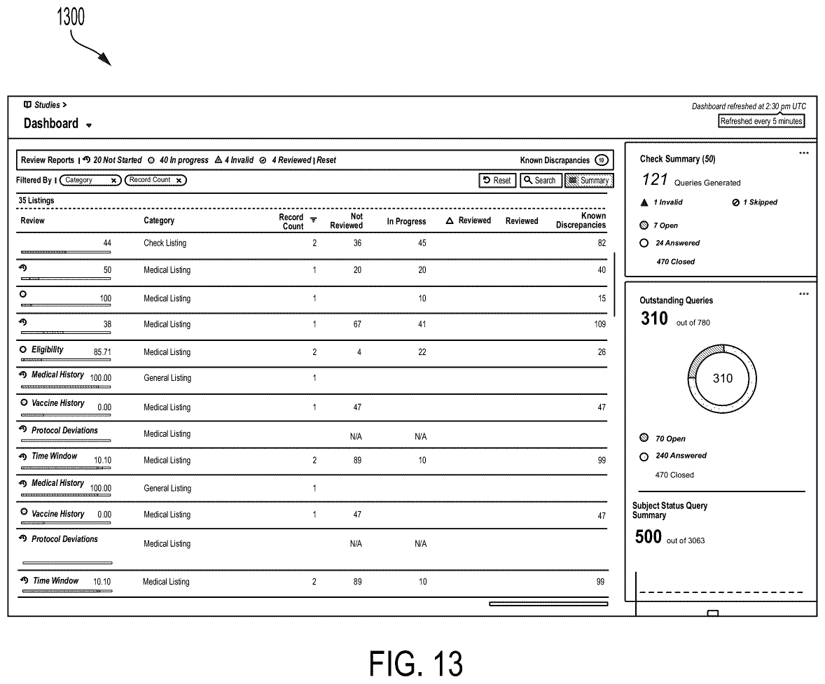

It is appreciated that one or more checks may be executed during change detection associated with the specialized database. The one or more checks could include applying a definition or a plurality of criteria to analyze different aspects of data. Such criteria may include data similarity property checks associated received and/or stored data in the specialized database, out-of-range property value checks associated with received and/or stored data in the specialized database, data duplication property checks or data version control property checks associated with the received and/or stored data associated with the specialized database, data security property checks associated with the received and/or stored data in the specialized database, etc. The definition(s) may be structured within a query or a number of queries that can be executed on a plurality of selected data at the same time and may affect one or more parameters associated with the selected data. The one or more parameters, for example, may comprise one or more of data status identifiers associated with the specialized database, data type identifiers associated with the specialized database, data name identifiers associated with the specialized database, data location identifiers associated with the specialized database, metadata identifiers associated with the specialized database, data definition identifiers associated with the specialized database, data package identifiers associated with the specialized database, data modification date identifiers associated with the specialized database, data key identifiers associated with the specialized database, data source identifiers associated with the specialized database, data review status identifiers associated with the specialized database, data discrepancy identifiers associated with the specialized database, data security identifiers associated with the specialized database, data format identifiers associated with the specialized database, data flag identifiers associated with the specialized database, etc. In the example of FIG. 12, automatic checks may be continuously and simultaneously executed on data records 1-4 with a summary log of said automatic checks generated below the data records 1-4 within an interface of the portal. Results of the checks may be forwarded via electronic communication to relevant stake-holders. In addition, the data engine may automatically generate queries associated with checks and close said queries once the checks are completed and there are not issues associated with the checked data record(s). For example, the data engine may automatically close one or more queries once the query is completed on a newly received version of data from the same data source when the query of the newly received version of data no longer identifies the previously-identified issue. In this manner, the query is automatically closed based entirely on the results of querying the data and without manual intervention to close the query. It is appreciated that the portal may include a dashboard interface that provides a plurality of metrics characterizing a plurality of checks being executed on stored data within the specialized database. FIG. 13 provides an example of such a dashboard 1300 that may be displayed on a user interface. A benefit of the dashboard 1300 in combination with other functionalities of the disclosed system is that data derived from multiple sources may be received, processed and flagged for issues or potential issues, and notifications sent to stake-holders associated with the data to authorize corrective action to the flagged issues.

According to some implementations, the data workbench provides a user interface coupled to the engines that drive the automatic checks and/or engines that drive the change-detection features discussed above. According to some embodiments, the engines that drive the automatic checks and/or engines that drive the change detection features are the data engine 140 or a component part of the data engine 140.

### Exemplary Embodiments

As previously discussed, the disclosed technology can facilitate:
1) executing “automatic checks” on aggregated data stored in the specialized database; and
2) executing “change detection” operations on aggregated data stored in the specialized database.

Executing the automatic checks may involve creating a query using a query language (e.g., a clinical query language (CQL)) associated with the specialized database to flag data outside of an allowed set of criteria for a specific data set. The specific dataset may be received from one or more data sources as previously noted. The created query may be automatically executed on the specific dataset within the specialized database on a minute-basis, on an hourly-basis, or on a daily-basis as the case may be. According to some embodiments, the data engine associated with the query may automatically notify, on a rolling basis a stake-holder (e.g., data manager, client, or some other user) through a user interface such as the user interfaces or graphical displays discussed in association with the portal above. The notifications may comprise electronic communications such as email, text messages, etc. and may indicate to the stake-holder whether there are identified data outside of the allowed set of criteria and which data was identified as outside of the allowed set of criteria. Data identified as outside of the allowed set of criteria may also be referred to as “flagged” data, “bad” data, or erroneous or inaccurate data, among other similar monikers. For example, data may include a date of birth field, and an automatic query may be created for that data that selects all data where the date of birth is infeasible (e.g., the individual has outlived the longest known lifespan for an individual or exceeds or fails to meet the expected age of individuals in a particular group of individuals whose data is being queried. The stake-holder may be directed to take one or more actions to resolve or otherwise address any issues associated with the flagged data. Some of the actions that the stake-holder may be directed to take include: verifying that the flagged data is accurate even though it is outside of the allowed set criteria; updating the flagged data to correct issues associated with the flagged data; or provide some other response including providing new data for updating the flagged data. The query may have an “opened” status for specific data when it determines that the specific data is outside of the allowed criteria. That query may have a “closed” status when the specific data is no longer outside of the allowed set of criteria indicating that identified issues associated with the specific data are resolved (e.g., by a stake-holder or by re-execution of the query or some other query to resolve identified issues associated with the specific data). When the query has a “closed” status because a second version of the data corrected an issue (e.g., an error, a discrepancy, an anomaly, etc.) associated with a first version of the specific data, the query no longer finds the data to flag and thus, automatically changes the query status to a “closed” status.

Executing the change detection operations may comprise receiving data from one or more sources as previously discussed. In particular, the data from the one or more sources may be ingested or otherwise received, aggregated or processed prior to storage in the specialized database. In some embodiments the different versions of the received data may be received at set times such as once a day, twice a day, three times a day, four times a day, on a daily basis, on a weekly basis, on a monthly basis, etc. In some embodiments, the data engine may determine any changes in the received and stored data. The changes may be based on whether values associated with the received and stored data have deviated out of bounds of expected value ranges for the received and stored data. The changes may also be based on whether the received and stored data differ from previous versions of the same data. In some cases, the changes may be based on changes from the expected constructs, configurations, or structures such as formats, record rows, record columns, or some other record entry modification associated with the stored data. These change detection operations may be executed automatically, with or without stake-holder input and may be based on one or more queries (e.g., CQL queries) executed to flag for the attention of a stake-holder any detected changes. In one embodiment, the detected changes may be logged into one or more reports and may be displayed in a user interface associated with the portal of the data engine. According to some implementations, an electronic notification (e.g., email, text message, etc.) may be sent to a stake-holder on a rolling basis to notify the stake-holder of any changes to stored data. In some cases, a stake-holder (e.g., data manager, client, or other user) may approve changes being made to the stored data, pause changes being applied to the stored data, or reject any changes being applied to the stored data. In some cases, changes being applied to the stored data may automatically be paused until a stakeholder takes some action. In some cases, the stake-holder may provide pre-approved instructions that may be automatically executed once specific changes are detected in the stored data within the specialized database. The instructions (automatic or otherwise) from the stake-holders facilitate avoidance of unexpected or undetected changes in the data down the line, such as when the data needs to be exported from the specialized database. When a change is approved or changed data is otherwise added to the specialized database, exporting the changed data, for example, may involve updating or reconciling export parameter(s) or definition(s) associated with the updated data within the specialized database. Using the example of exporting data based on changes to the data within the specialized database, the user interface of the portal may flag one or more sections of the export definition that may need to be updated/reconciled to ensure that the exported data is compatible for export (for example, meets required export criteria such that the data engine 140 or an export engine may execute an export operation without the operation crashing or otherwise failing to export certain data) and with other systems of stake-holders.

According to one embodiment, data is received from a plurality of sources and in a plurality of formats. The data is then stored in a specialized database having a collection of standardized data in a standardized format. According to one embodiment, standardized data comprises data that has been formatted or otherwise resolved to remove discrepancies or noise and/or conformed to a data structure of the specialized database. According to one embodiment, the standardized data comprises data that has been formatted to remove at least one discrepancy and to make the received data from the plurality of sources compatible for storage within the standardized database. Access to the specialized database is enabled over a network such that a stake-holder can view and update the data in real time through a graphical user interface. The graphical user interface also enables a stake-holder to respond to detected changes in data or data flagged as outside of the expected range for the data. The stake-holder may respond by providing updated data in a non-standardized format dependent on the client-based system of the stake-holder. The data engine 140 may convert the non-standardized updated data into a standardized format, which is then stored in the specialized database having a collection of standardized data. Upon detecting changes in data or data flagged as outside of the expected range for the data, or upon storing the standardized updated data, a message containing the identified changes in data or data flagged as outside of the expected range or standardized updated data is automatically generated and transmitted to one or more stake-holders via electronic communications over the network in real-time or near real-time for immediate access to identified changes in data, potential data inaccuracies or errors, and standardized updated data.

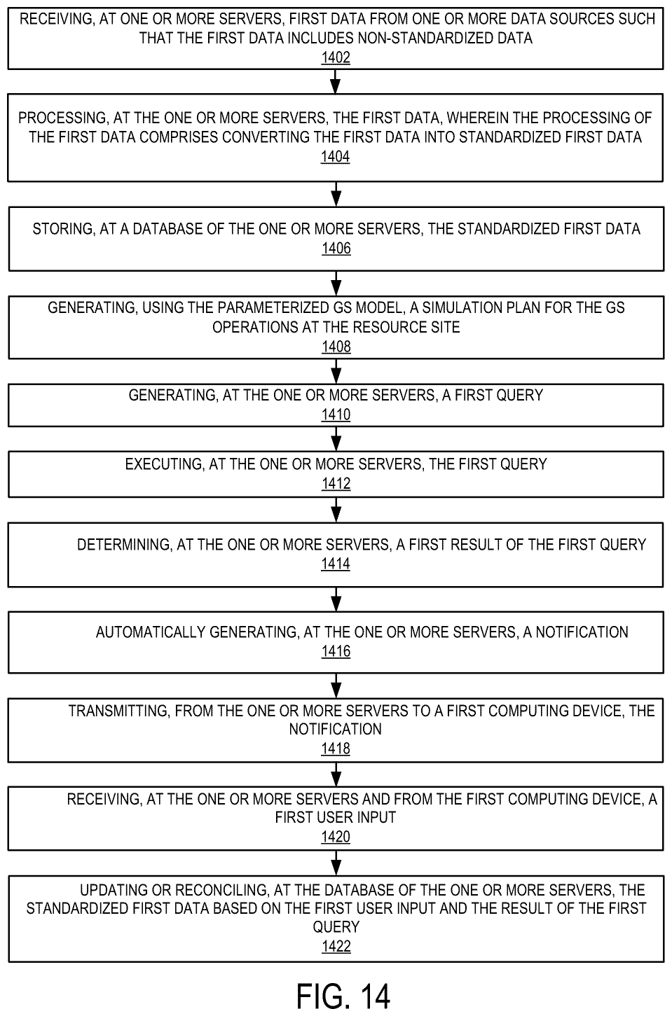

The disclosed methods and systems are directed to updating/reconciling standardized data (e.g., first data) based on an automatically generated notification as exemplified in the flowchart of FIG. 14. It is appreciated that a data engine 140 stored in a memory device may cause a computer processor to execute one or more processing stages outlined in FIG. 14. At block 1402, the data engine may receive, at one or more servers, first data from one or more data sources such that the first data includes non-standardized data. The data engine may process, at the one or more servers, the first data, wherein the processing of the first data comprises converting the first data into standardized first data at block 1404. In one embodiment, the standardized first data comprises data that has been formatted: to remove at least one discrepancy within the first data; or to enable a compatibility of the first data for storage within the database. At block 1406, the data engine may store, at a database of the one or more servers, the standardized first data and generate, at the one or more servers, a first query as indicated at block 1410. According to one embodiment, the first query is based on a query language compatible with the database and executable instructions for performing at least one operation within the database based on at least one of a first parameter associated with the standardized first data, a second parameter associated with the database, or a third parameter associated with the first query. According to one embodiment, one or more of the first parameter, or the second parameter, or the third parameter is associated with one of a data status identifier; a data location identifier; a data discrepancy identifier; or a data flag identifier. At block 1412, the data engine may execute, at the one or more servers, the first query. In some embodiments, executing of the first query comprises searching the database based on the at least one of the first parameter, the second parameter, or the third parameter. At block 1414, the data engine may determine, at the one or more servers, a first result of the first query. The first result of the first query, according to one embodiment, identifies or comprises second data, and such that the second data fails to satisfy at least one criteria of the first query. Moreover, the at least one criteria may be based on at least one of the first parameter, the second parameter, or the third parameter. The data engine may automatically generate, at the one or more servers, a notification, the notification comprising an identifier that flags that the second data failed to meet the at least one criteria of the first query at block 1416. At block 1418, the data engine may transmit, from the one or more servers to a first computing device, the notification. The data engine may receive, at the one or more servers and from the first computing device, a first user input at block 1420. At block 1422, the data engine may update or reconcile, at the database of the one or more servers, the standardized first data based on the first user input and the result of the first query.

These and other implementations may each optionally include one or more of the following features. The database described in association with FIG. 14 is a metadata-driven database having a data structure that is queried using a clinical query language (CQL). Moreover, a manifest file describing at least one data element of the first data may be used to execute one or more of interpreting a structure of the first data prior to processing the first data; or determining one or more keys associated with the first data such that the one or more keys are used to transform one or more properties of the first data. In some embodiments, the one or more keys are associated with the first data and may facilitate mapping of the one or more properties of the first data to one or more of: a data structure associated with the database; or a data format associated with the database. Furthermore, the manifest file, according to some embodiments, indicates at least one of source information associated with the first data; a data type associated with the first data; a format associated with the first data; and one or more data values associated with the first data. In some embodiments, the manifest file provides a data structure for interpreting the first data for storage within the database. It is appreciated that the data type may indicate one or more precision properties (e.g., quantitative precision properties including decimal resolution data) associated with the received data. It is further appreciated that the data format may indicate one or more configurable display properties (e.g., graphical display element size properties, display element orientation and arrangement properties, etc.) associated with the first data. In addition, reconciling the standardized first data may comprise generating an export definition for the first data and enabling data compatibility of the first data for use on the first computing device based on the export definition. According to one embodiment, reconciling the standardized first data comprises generating an export definition for the first data, and generating, based on the export definition, a specification of a data format, a data structure, or a visualization type for presenting one or more of the notification, the standardized data, or the second data on a display device. In some embodiments, the reconciling the standardized first data comprises generating, based on the export definition, one or more of a first consistency report for the first data; or a second consistency report indicating a change to the first data. Moreover, the one or more data sources may include at least one computing server associated with one or more of a medical facility, a research institution, a government institution, or an educational institution. According to some embodiments, the first query comprises one or more checks on data within the database such that the first query is associated with a plurality of criteria including the at least one criteria such that the plurality of criteria include one or more of a data similarity property check comprised the one or more checks; an out-of-range property value check comprised in the one or more checks; a data duplication property check comprised in the one or more checks; or a data security property check comprised in the one or more checks. In one embodiment, the first data comprises a file that is loaded into a data lake associated with the database and with which the database communicates via an application programming interface, the data lake comprising a plurality of raw unprocessed data from the one or more data sources and/or from a source or server distinct from the one or more data sources.

Any embodiments, described herein can be combined with any other embodiments described herein or can be combined with embodiments described in patent applications or patents incorporated by reference herein.

This application incorporates by reference U.S. application Ser. No. 17/157,863, filed on Jan. 25, 2021, which is a continuation of U.S. application Ser. No. 16/527,779, filed on Jul. 31, 2019, which is a continuation-in-part of U.S. application Ser. No. 16/172,596, filed on Oct. 26, 2018, which is a continuation of U.S. application Ser. No. 15/881,516, filed on Jan. 26, 2018, which is a continuation of U.S. application Ser. No. 15/847,637, filed on Dec. 19, 2017, which is a continuation-in-part of U.S. application Ser. No. 14/611,012, filed on Jan. 30, 2015, which is a continuation-in-part of U.S. application Ser. No. 14/271,134, filed on May 6, 2014, which claims priority to U.S. Provisional Patent Application Nos. 61/820,029, filed May 6, 2013, and 61/828,034, filed May 28, 2013, all of which are hereby incorporated by reference herein for all purposes.

U.S. application Ser. No. 15/847,637 incorporates by reference U.S. application Ser. No. 14/558,432, filed on Dec. 2, 2014, which is a continuation-in-part of U.S. application Ser. No. 14/271,134, filed on May 6, 2014, which claims priority to U.S. Provisional Patent Application Nos. 61/820,029, filed May 6, 2013, and 61/828,034, filed May 28, 2013, all of which are hereby incorporated by reference herein for all purposes.

U.S. application Ser. No. 15/847,637 incorporates by reference U.S. application Ser. No. 14/613,293, filed on Feb. 3, 2015, which is a continuation-in-part of U.S. application Ser. No. 14/271,134, filed on May 6, 2014, which claims priority to U.S. Provisional Patent Application Nos. 61/820,029, filed May 6, 2013, and 61/828,034, filed May 28, 2013, all of which are hereby incorporated by reference herein for all purposes.

U.S. application Ser. No. 15/847,637 incorporates by reference U.S. application Ser. No. 14/699,553, filed on Apr. 29, 2015, which is a continuation of U.S. application Ser. No. 14/271,134, filed on May 6, 2014, which claims priority to U.S. Provisional Patent Application Nos. 61/820,029, filed May 6, 2013, and 61/828,034, filed May 28, 2013, all of which are hereby incorporated by reference herein for all purposes.

U.S. application Ser. No. 15/847,637 is a continuation-in-part of U.S. application Ser. No. 15/629,587, filed on Jun. 21, 2017, which claims priority to U.S. Provisional Patent Application No. 62/407,399, filed on Oct. 12, 2016, which is hereby incorporated by reference herein for all purposes.

U.S. application Ser. No. 15/847,637 is a continuation-in-part of U.S. application Ser. No. 14/819,371, filed on Aug. 5, 2015, which is a continuation-in-part of U.S. application Ser. No. 14/702,307, filed on May 1 2015, both of which are hereby incorporated by reference herein for all purposes.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more.

Various terms used herein have special meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method of updating standardized first data based on an automatically generated notification, the method comprising:
receiving, at one or more servers, first data from one or more data sources, the first data including non-standardized data;
processing, at the one or more servers, the first data, wherein the processing of the first data comprises converting the first data into standardized first data;
storing, at a database of the one or more servers, the standardized first data;
generating, at the one or more servers, a first query, wherein the first query is based on a query language compatible with the database and executable instructions for performing at least one operation within the database based on at least one of a first parameter associated with the standardized first data, a second parameter associated with the database, or a third parameter associated with the first query;
executing, at the one or more servers, the first query, wherein the executing of the first query comprises searching the database based on the at least one of the first parameter, the second parameter, or the third parameter;
determining, at the one or more servers, a first result of the first query, wherein the first result of the first query identifies or comprises second data, wherein the second data fails to satisfy at least one criteria of the first query, and wherein the at least one criteria is based on at least one of the first parameter, the second parameter, or the third parameter;
receiving, at the one or more servers and from a first computing device, a first user input; and
updating or reconciling, at the database of the one or more servers, the standardized first data based on the first user input and the result of the first query.

2. The method of claim 1, further comprising:
automatically generating, at the one or more servers, a notification, wherein the notification comprises an identifier that flags that the second data failed to meet the at least one criteria of the first query; and
transmitting, from the one or more servers to a first computing device, the notification.

3. The method of claim 1, wherein reconciling the standardized first data comprises:
generating an export definition for the first data; and
enabling data compatibility of the first data for use on the first computing device based on the export definition.

4. The method of claim 1, wherein the database is a metadata-driven database having a data structure that is queried using a clinical query language (CQL).

5. The method of claim 1, wherein a manifest file describing at least one data element of the first data is used to execute one or more of:
interpreting a structure of the first data prior to processing the first data; or
determining one or more keys associated with the first data such that the one or more keys are used to transform one or more properties of the first data.

6. The method of claim 5, wherein the one or more keys facilitate mapping of the one or more properties of the first data to one or more of:
a data structure associated with the database; or
a data format associated with the database.

7. The method of claim 5, wherein the manifest file indicates at least one of source information associated with the first data;
a data type associated with the first data;
a format associated with the first data; and
one or more data values associated with the first data.

8. The method of claim 7, wherein:
the data type indicates one or more precision properties associated with the first data; and
the data format indicates one or more configurable display properties associated with the first data.

9. A system for updating standardized first data based on an automatically generated notification, the system comprising:
a computer processor, and
memory storing a data engine that comprises instructions that are executable by the computer processor to:
receive, at one or more servers, first data from one or more data sources, the first data including non-standardized data;
process, at the one or more servers, the first data, wherein the processing of the first data comprises converting the first data into standardized first data;
store, at a database of the one or more servers, the standardized first data;
generate, at one or more servers, a first query, wherein the first query is based on a query language compatible with the database and executable instructions for performing at least one operation within the database based on at least one of a first parameter associated with the standardized first data, a second parameter associated with the database, or a third parameter associated with the first query;
execute, at the one or more servers, the first query, wherein the executing of the first query comprises searching the database based on the at least one of the first parameter, the second parameter, or the third parameter;
determine, at the one or more servers, a first result of the first query, wherein the first result of the first query identifies or comprises second data, wherein the second data fails to satisfy at least one criteria of the first query, and wherein the at least one criteria is based on the at least one of the first parameter, the second parameter, or the third parameter; and
update or reconcile, at the database of the one or more servers, the standardized first data based on a first user input and the result of the first query.

10. The system of claim 9, wherein the instructions are further executable by the computer processor to:
automatically generate, at the one or more servers, a notification, wherein the notification comprises an identifier that flags that the second data failed to meet the at least one criteria of the first query;
transmit, from the one or more servers to a first computing device, the notification; and
receive, at the one or more servers and from the first computing device, the first user input.

11. The system of claim 9, wherein the database is a metadata-driven database having a data structure that is queried using a clinical query language (CQL).

12. The system of claim 9, wherein:
the first query comprises one or more checks on data within the database;
the first query is associated with a plurality of criteria including the at least one criteria, the plurality of criteria including one or more of:
a data similarity property check comprised in the one or more checks;
an out-of-range property value check comprised in the one or more checks;
a data duplication property check comprised in the one or more checks; or
a data security property check comprised in the one or more checks.

13. The system of claim 9, wherein one or more keys associated with the first data facilitate mapping of one or more properties of the first data to one or more of:
a data structure associated with the database; or
a data format associated with the database.

14. The system of claim 9, wherein the first data comprises a file that is loaded into a data lake associated with the database and with which the database communicates via an application programming interface, the data lake comprising a plurality of raw unprocessed data from the one or more data sources or from a source or server distinct from the one or more data sources.

15. The system of claim 9, wherein to reconcile the standardized first data comprises:
generating an export definition for the first data; and
enabling data compatibility of the first data for use on a first computing device based on the export definition.

16. The system of claim 9, wherein one or more of the first parameter, or the second parameter, or the third parameter is associated with or comprises one of:
a data status identifier;
a data location identifier;
a data discrepancy identifier; or
a data flag identifier.

17. A computer program product for updating standardized first data based on an automatically generated notification, the computer program product comprising a non-transitory computer-readable medium comprising code configured to:
receive, at one or more servers, first data from one or more data sources, the first data including non-standardized data;
process, at the one or more servers, the first data, wherein the processing of the first data comprises converting the first data into standardized first data;
store, at a database of the one or more servers, the standardized first data;
generate, at one or more servers, a first query, wherein the first query is based on a query language compatible with the database and executable instructions for performing at least one operation within the database based on at least one of a first parameter associated with the standardized first data, a second parameter associated with the database, or a third parameter associated with the first query;
execute, at the one or more servers, the first query, wherein the executing of the first query comprises searching the database based on at least one of the first parameter, the second parameter, or the third parameter;
determine, at the one or more servers, a first result of the first query, wherein the first result of the first query identifies or comprises second data, wherein the second data fails to satisfy at least one criteria of the first query;
receive, at the one or more servers and from a first computing device, a first user input; and
update or reconcile, at the database of the one or more servers, the standardized first data based on the first user input and the result of the first query.

18. The computer program product of claim 17, wherein the code comprised in the non-transitory computer-readable medium is further configured to:
automatically generate, at the one or more servers, a notification, wherein the notification comprises an identifier that flags that the second data failed to meet the at least one criteria of the first query; and
transmit, from the one or more servers to the first computing device, the notification.

19. The computer program product of claim 17, wherein the at least one criteria is based on at least one of the first parameter, the second parameter, or the third parameter.

20. The computer program product of claim 17, wherein the database is a metadata-driven database having a data structure that is queried using a clinical query language (CQL).

21. The computer program product of claim 17, wherein to reconcile the standardized first data comprises:
to generate an export definition for the first data; and
to generate, based on the export definition, one or more of enabling a specification of a data format, a data structure, or a visualization type for presenting one or more of:
the notification;
the standardized data; or
the second data on a display device.

22. The computer program product of claim 21, wherein to reconcile the standardized first data comprises one or more of:
to generate, based on the export definition, a first consistency report for the first data; or
to generate, based on the export definition, a second consistency report indicating a change to the first data.

23. The computer program product of claim 17, wherein a manifest file comprises or is based on a data structure for interpreting the first data for storage within the database.

24. The computer program product of claim 17, wherein the standardized first data comprises data that has been formatted:
to remove at least one discrepancy within the first data; or
to enable a compatibility of the first data for storage within the database.
